(19) United States
(12) Patent Application Publication
(10) Pub. No.: US 2022/0335910 A1
(43) Pub. Date: Oct. 20, 2022

(54) APPARATUS, SYSTEMS, AND RELATED METHODS FOR DISPLAY PANEL POWER SAVINGS DURING STYLUS USAGE

(71) Applicant: Intel Corporation, Santa Clara, CA (US)

(72) Inventors: Praveen Kashyap Ananta Bhat, Bangalore (IN); Navneet Kumar Singh, Bangalore (IN); Samarth Alva, Bangalore (IN); Aiswarya Pious, Bangalore (IN); Susanta Bhattacharjee, Bangalore (IN); Karthika Murthy, Bangalore (IN); Mallari Hanchate, Bangalore (IN); Antonio Cheng, Portland, OR (US)

(21) Appl. No.: 17/856,176

(22) Filed: Jul. 1, 2022

(51) Int. Cl. G09G 5/10; G06F 3/0354; G06F 3/038; G06F 3/041

(52) U.S. Cl. CPC G09G 5/10; G06F 3/03545; G06F 3/0383; G06F 3/04186; G09G 2320/0686; G09G 2330/022

(57) ABSTRACT

Apparatus, systems, and methods for display panel power savings during stylus usage are disclosed. An example apparatus includes interface circuitry to receive touch event location data indicative of touch events by a user on a display screen of an electronic device; and processor circuitry to perform operations to instantiate display mapping circuitry to identify an area of the display screen covered by a portion of a body of the user based on a shape of the portion; and pixel identification circuitry to identify respective ones of pixels of the display screen in the area of the display screen; and cause a property of the respective ones of the pixels to be adjusted.

### FIELD OF THE DISCLOSURE

This disclosure relates generally to electronic devices having touch screens and, more particularly, to apparatus, systems, and related methods for display panel power savings during stylus usage.

### BACKGROUND

A user may interact with a touch screen of an electronic device by providing touch inputs. In some instances, the touch inputs are provided via a stylus or other instrument such as a digital pen.

### BRIEF DESCRIPTION OF THE DRAWINGS

FIG. 1 illustrates an example system constructed in accordance with teachings of this disclosure.

FIG. 2 is a block diagram of an example implementation of the touch control circuitry of FIG. 1.

FIG. 3 is a block diagram of an example implementation of the pixel control circuitry of FIG. 1.

FIGS. 4-6 illustrate an example touch event on the display screen of FIG. 1 and corresponding adjustments to the display screen in response to the touch event.

FIG. 7 is a block diagram of an example implementation of the display temperature control circuitry of FIG. 1.

FIG. 8 is a flowchart representative of example machine readable instructions and/or example operations that may be executed or instantiated by example processor circuitry to implement the touch control circuitry of FIG. 2.

FIG. 9 is a flowchart representative of example machine readable instructions and/or example operations that may be executed or instantiated by example processor circuitry to implement the pixel control circuitry of FIG. 2.

FIG. 10 is a flowchart representative of example machine readable instructions and/or example operations that may be executed or instantiated by example processor circuitry to implement the display temperature control circuitry of FIG. 7.

FIG. 11 is a block diagram of an example processing platform including processor circuitry structured to execute the example machine readable instructions and/or the example operations of FIG. 8 to implement the touch control circuitry of FIG. 2.

FIG. 12 is a block diagram of an example processing platform including processor circuitry structured to execute the example machine readable instructions and/or the example operations of FIG. 9 to implement the pixel control circuitry of FIG. 3.

FIG. 13 is a block diagram of an example processing platform including processor circuitry structured to execute the example machine readable instructions and/or the example operations of FIG. 10 to implement the display temperature control circuitry of FIG. 7.

FIG. 14 is a block diagram of an example implementation of the processor circuitry of FIGS. 11, 12, and/or 13.

FIG. 15 is a block diagram of another example implementation of the processor circuitry of FIGS. 11, 12, and/or 13.

FIG. 16 is a block diagram of an example software distribution platform (e.g., one or more servers) to distribute software (e.g., software corresponding to the example machine readable instructions of FIGS. 8, 9, and/or 10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

An electronic device such as an electronic tablet or a laptop can include a display panel having a touch screen to enable a user to interact with the device by providing touch inputs. The touch inputs can be provided by the user using, for instance, a stylus or other instrument such as a digital pen. (The term “stylus” will be generally used herein to refer to instruments to provide touch inputs via a display screen and can include passive instruments that do not include electronics and/or digital instruments including electronics (i.e., digital pens)). The input(s) provided via the stylus can include input(s) that mimic writing or drawing, such as executing a signature, underling text presented on the display screen, etc.

When the user is interacting with the device using the stylus, the display panel may operate at an increased refresh rate, or an increased frequency at which the display panel updates the image(s) presented via the display screen, as compared to when, for instance, inputs are provided via a mouse or touch pad. The increased refresh rate during stylus usage can provide for smoother visual quality of the images in response to input(s) provided via the stylus (e.g., the appearance of a smooth line drawn on the screen via the stylus). However, the increased refresh rate of the display panel can result in increased power consumption by the device and, thus, affect, for instance, a battery charge of the device, an amount of heat generated by the device, etc.

During use of a stylus, a user may rest a portion of one or more of his or her hands and/or arms on the display screen similar to as if the user were writing on a piece of paper. For instance, a portion of the palm(s), wrist(s), and/or forearm(s) of the user may be in contact with the display screen while the user is interacting with the device via the stylus. (As used herein, the phrase “in contact with” is defined to mean that there is no intermediate part between the display screen and a portion of the user, such as a hand of the user). In some instances, portion(s) of the user's hand(s) and/or arm(s) may hover over the display screen while the user is using the stylus. As a result of the contact or hovering of the user's hand(s) and/or arm(s) relative to the display screen, area(s) of the display screen are covered or substantially covered by the portion(s) of the user's hand(s) and/or arm(s). In some instance, a user's hand(s) and/or arm(s) may cover 10% to 20% of the display screen. Thus, in some instances, content on the display screen is covered or not visible due to the presence of the user's hand(s) and/or arm(s) relative to the display screen.

In some instances, heat generated during operation the device by, for instance, a central processing unit of the device, can be transferred to and/or emitted by the display screen of the device. For example, the device can include a laptop having a base hingedly coupled to a display housing. In some instances, the laptop can be converted to a tablet by rotating the base to rest against the display housing. In some instances, heat generated by the central processing unit of the device located in the base can be transferred to the display housing and increase a temperature of the display screen (e.g., an increase of three or four degrees Celsius). As discussed above, during usage of the stylus, portion(s) of the user's hand(s) and/or arm(s) may be in contact with (e.g., rest on) the display screen. In some instances, the user's hand(s) and/or arm(s) may contact the display screen for a longer when the user is using a stylus as compared to when the user provides touch input(s) using his or her finger. For instance, the use may perform actions such as writing or drawing on the display screen using a stylus while performing single taps via the user's finger. Thus, in some instance, the user may feel the heat emitted by the display screen when using the stylus.

Disclosed herein are example systems, apparatus, and methods for providing power savings at a device when a user is interacting with the device via a stylus and/or otherwise providing touch inputs such that at least a portion of the user's hand(s) and/or arm(s) are covering area(s) of a display screen of the device. Examples disclosed herein selectively control pixels of the display screen located within area(s) of the display screen covered by portion(s) of the user's hand(s) and/or arm(s). Examples disclosed herein determine (e.g., predict) a shape of the portion(s) of the user's hand(s) and/or arm(s) in contact with or hovering over the display screen and, thus, covering area(s) of the display screen. Some examples disclosed herein use touch event location data generated by touch control circuitry of the device to determine the shape of the portion(s) of the user's hand(s) and/or arm(s) in contact with (e.g., resting on) the display screen. The touch event location data can indicate touch events that are not associated with intentional touch inputs by the user (i.e., are not meant to invoke a response from the device 102), but instead, result from the user resting portion(s) of his or her hand(s) and/or arm(s) on the display screen (e.g., as recognized by the touch control circuitry using palm rejection algorithms). Some examples disclosed herein use image data and/or presence detection sensors to recognize a presence of the user's hand(s) and/or arm(s) hovering over the display screen during stylus usage.

Examples disclosed herein use the unintended touch event data, the image data, and/or the proximity sensor data to identify area(s) of the display screen that are covered, substantially covered, or likely to be covered (e.g., due to movement) by the user's hand(s) and/or arm(s). Some examples disclosed herein generate a map (e.g., a bitmap) identifying the pixels of the display panel located within the covered area(s) of the display screen. Some examples disclosed herein cause the pixels located within the covered area(s) of the display screen to turn off. Some examples disclosed herein reduce a brightness of the pixels located within the covered area(s) of the display screen. Because the area(s) of the display screen having the adjusted pixels (i.e., the pixels that are turned off, dimmed, made static (e.g., not change with respect to emitting light from a current color light emitted by a respective pixel 108), etc.) are not visible to the user due to the user's hand and/or arm covering those area(s) of the display screen, the adjustments to the pixels can reduce power consumption by the device without affecting the user's experience in viewing content on the display screen.

Some examples disclosed herein adjust one or more other parameters of the device to reduce power consumption during stylus usage. As discussed above, during usage of the stylus, portion(s) of the user's hand(s) and/or arm(s) may be in contact with (e.g., rest on) the display screen. Some examples disclosed herein monitor a temperature of the display screen (e.g., wherein the display screen defines a skin or an exterior surface of the display panel that the user interacts with). Examples disclosed herein compare the display screen temperature to a threshold temperature. In examples in which the display screen temperature exceeds the threshold temperature, examples disclosed herein select one or more parameters of the device to adjust to reduce an amount of heat generated by the device (and, thus, an amount of heat emitted by the display screen). For instance, some examples disclosed herein cause a charging rate of a battery to be reduced when the device is electrically coupled to an alternating current source. Some examples disclosed herein cause the central processing unit of the device to throttle (e.g., adjust a clock speed or voltage) to reduce power consumption and, thus, heat generated by the device. Examples disclosed herein dynamically tune or improve (e.g., optimize) parameters of the electronic device to balance power consumption and heat generated by the device in view of interactions between the user and the display screen during use of a stylus with the display screen.

Although examples disclosed herein are discussed in connection with stylus usage and, in particular, a user resting or hovering his or her hand(s) and/or arm(s) relative to a display screen during stylus usage, examples disclosed herein could additionally or alternatively be used in connection with other examples in which a user may rest or hover his or her hand(s) and/or arm(s) relative to a display screen while interacting with an electronic device. For instance, examples disclosed herein could be used when the user is resting his or her hand(s) and/or arm(s) on the display screen while reading a document, playing a game, etc. using the electronic device.

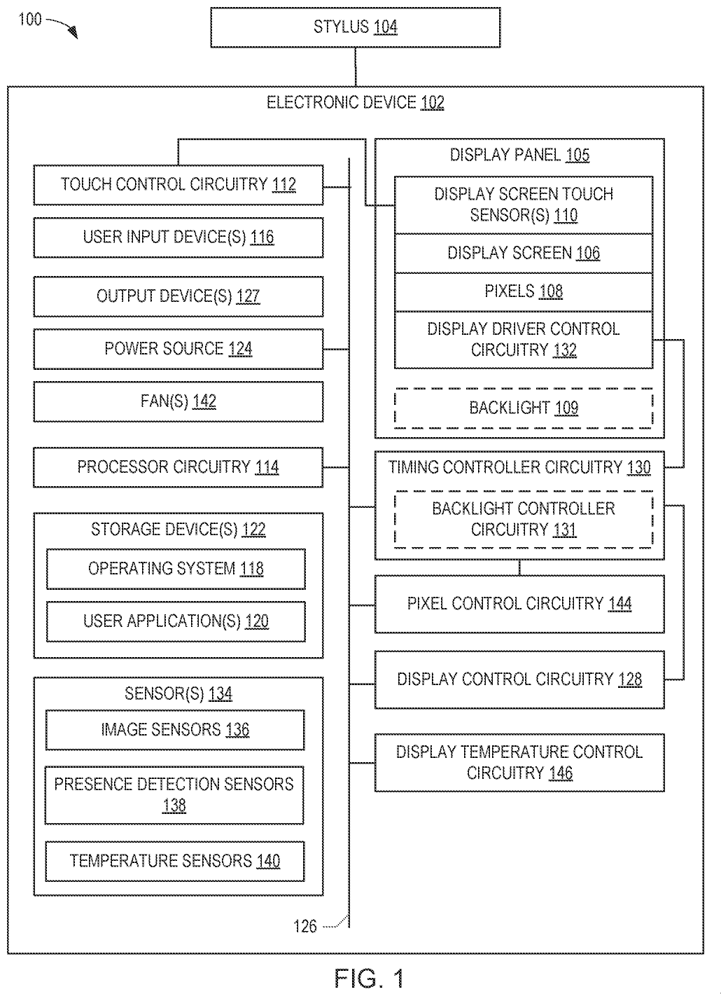

FIG. 1 illustrates an example system 100 constructed in accordance with teachings of this disclosure for adjusting parameters of an electronic device 102 in response to usage of a stylus 104 by a user to interact with the electronic device 102. (The terms “user” and “subject” are used interchangeably herein and both refer to a human being). The electronic device 102 can be, for example, a personal computing device such as a laptop computer, a desktop computer, an electronic tablet, an all-in-one PC, a hybrid or convertible PC, a mobile phone, a monitor, etc. As disclosed herein, the term “stylus” is generally used herein to refer to instruments to provide touch inputs via a display screen and can include passive instruments that do not include electronics and/or digital instruments including electronics (i.e., digital pens). Also, although examples disclosed herein are discussed in connection with usage of the stylus 104 to provide touch inputs, examples disclosed herein could additionally or alternatively be implemented in response to touch inputs provided by a user using, for instance, a finger of the user's hand.

The example electronic device 102 of FIG. 1 includes a display panel 105. The display panel 105 includes a display screen 106 and an array of pixels 108 to display images that are viewable via the display screen 106 of. The pixels 108 can be implemented using light emitting diode (LED) technology such as, for example, micro-LED, organic LED (OLED), or mini-LED technology. The pixels 108 include corresponding light emitters. For instance, each of the pixels 108 can include three different ones of the light emitters, all of which emit either a red color light, a green color light, or a blue color light.

In operation, multiples ones of the pixels 108 are operated (e.g., illuminated and/or color emitter operated) at different times (e.g., with different timing sequences) to display an image (e.g., a two-dimensional image) on the display screen 106. In particular, a signal is provided to the display panel 105 and different ones of the light emitters of the pixels 108 are driven and/or controlled for a given image (e.g., a video frame, a still picture, etc.) of the signal. In particular, different ones of the light emitters of the pixels 108 are provided with a current based on the signal.

In some examples, the display panel 105 is a liquid crystal display (LCD), where the pixels 108 have a liquid crystal layer. In such examples, the display panel 105 includes a backlight 109 to illuminate the pixels 108. The backlight 109 enables an image produced by the pixels 108 to be visible to the user. In examples in which the display panel 105 is based on, for instance, OLED or micro-LED technology, the display panel 105 may not include the backlight 109 because the pixels 108 include the light emitters.

The display screen 106 of the display panel 105 defines a skin or exterior surface of the display panel 105 through which the user view content, provides input(s), etc. The display screen 106 can include glass. In the example of FIG. 1, the display screen 106 is a touch screen that enables a user to interact with data presented on the display screen 106 by touching the display screen 106 with the stylus 104 and/or one or more fingers or a hand of the user. The example display screen 106 includes one or more display screen touch sensor(s) 110 that detect electrical changes (e.g., changes in capacitance, changes in resistance) in response to touches on the touch screen. In some examples, the display screen 106 is a capacitive display screen. In such examples, the display screen touch sensors 110 include sense lines that intersect with drive lines carrying current. The sense lines transmit signal data when a change in voltage is detected at locations where the sense lines intersect with drive lines in response to touches on the display screen 106. In other examples, the display screen 106 is a resistive touch screen and the display screen touch sensor(s) 110 include sensors that detect changes in voltage when conductive layers of the resistive display screen 106 are pressed together in response to pressure on the display screen 106 from the touch. In some examples, the display screen touch sensor(s) 110 can include force sensor(s) that detect an amount of force or pressure applied to the display screen 106 by the user's finger or stylus.

The example electronic device 102 of FIG. 1 includes touch control circuitry 112 to process the signal data generated by the display screen touch sensor(s) 110 when the user's finger(s) or the stylus 104 touch the display screen 106. The touch control circuitry 112 interprets the signal data to identify particular locations of touch events on the display screen 106 (e.g., where voltage change(s) were detected by the sense line(s) in a capacitive touch screen). The touch control circuitry 112 communicates the touch event(s) to, for example, processor circuitry 114 (e.g., a central processing unit) of the electronic device 102. Additionally or alternatively, the user can interact with data presented on the display screen 106 via one or more user input devices 116, such as a keyboard, a mouse, a touch pad, etc. In some examples, the touch control circuitry 112 is implemented by dedicated circuitry in communication with the processor circuitry 114. In some examples, the touch control circuitry 112 is implemented by the processor circuitry 114.

The processor circuitry 114 of the illustrated example is a semiconductor-based hardware logic device. The hardware processor circuitry 114 may implement a central processing unit (CPU) of the electronic device 102, may include any number of cores, and may be implemented, for example, by a processor commercially available from Intel® Corporation. The processor circuitry 114 executes machine readable instructions (e.g., software) including, for example, an operating system 118 and/or other user application(s) 120 installed on the electronic device 102, to interpret and output response(s) based on the user input event(s) (e.g., touch event(s), keyboard input(s), etc.). The operating system 118 and the user application(s) 120 are stored in one or more storage devices 122. The electronic device 102 of FIG. 1 includes a power source 124 such as a battery and/or a transformer and AC/DC convertor to provide power to the processor circuitry 114 and/or other components of the electronic device 102 communicatively coupled via a bus 126. The example electronic device 102 includes one or more output devices 127 (e.g., speaker(s)) to provide outputs to a user. Some or all of the processor circuitry 114 and/or storage device(s) 122 may be located on a same die and/or on a same printed circuit board (PCB).

Display control circuitry 128 (e.g., a graphics processing unit (GPU)) of the example electronic device 102 of FIG. 1 controls operation of the display panel 105 and facilitates rending of content (e.g., display frame(s) associated with graphical user interface(s)) via the display screen 106. As discussed above, the display screen 106 is a touch screen that enables the user to interact with data presented on the display screen 106 by touching the screen with the stylus 104 and/or one or more fingers of a hand of the user. In some examples, the display control circuitry 128 is implemented by dedicated circuitry in communication with the processor circuitry 114. In some examples, the display control circuitry 128 is implemented by the processor circuitry 114.

The example electronic device 102 include display timing controller circuitry 130 (e.g., a TCON). The timing controller circuitry 130 receives display signal data representing image data (e.g., video, still image(s)) to be presented on the display screen 106 from the display control circuitry 128. In some examples, the timing controller circuitry 130 controls and/or adjusts the image data with respect to variables such as color and brightness prior to presentation of the image data. In examples in which the display panel 105 include the backlight 109, the timing controller circuitry 130 includes backlight controller circuitry 131 to control operation (e.g., a brightness) of the backlight 109.

The timing controller circuitry outputs display input signals (e.g., pixel display signals) to display driver control circuitry 132 of the display panel 105 to control operation of the pixels 108 and a refresh rate of the display screen 106. The display driver control circuitry 132 can include source drivers and row drivers. For example, driver control circuitry 132 controls an intensity (e.g., light intensity) and color display (e.g., color output) of the pixels 108. The driver control circuitry 132 transmits display signals to the pixels 108 as well as clock information to control presentation of images on the display screen 106.

The example electronic device 102 includes a plurality of sensors 134. For example, the electronic device 102 of FIG. 1 includes one or more image sensors 136 to capture images of an environment in which the electronic device 102 is located.

The example electronic device 102 of FIG. 1 includes one or more presence detection sensors 138. In the example of FIG. 1, data corresponding to signals output by the presence detection sensors 138 is used to detect a presence of portion(s) of hand(s) and/or arm(s) (e.g., palm(s), wrist(s), forearm(s)) of the user that are hovering over, but not in contact with, the display screen 106 while the user is interacting with the display screen 106 via the stylus 104. In some examples, the presence detection sensor(s) 138 define a sensor array (e.g., a film) disposed over at least a portion of the display screen 106. The presence detection sensor(s) 138 can generate an electric field and emit signals indicative of changes in the electric field due to the presence of the user's hand(s) and/or arm(s) within proximity of the electric field.

The example electronic device 102 includes one or more temperature sensors 140. The temperature sensors 140 monitor a temperature of one or more components of the electronic device 102. For example, the temperature sensors 140 can measure a temperature of the processor circuitry 114 (e.g., a central processing unit) during operation of the electronic device 102. The temperature sensors 140 can measure a temperature of a housing (e.g., skin) of the electronic device 102. The example electronic device 102 includes one or more fans 142 that generate airflow to cool the device 102.

In the example of FIG. 1, the display panel 105 includes one or more of the temperature sensors 140 to monitor a temperature of the display screen 106 (i.e., a skin or exterior surface of the display panel 105). As disclosed herein, heat generated by, for instance the processor circuitry 114, the display panel 105, etc. during operation of the electronic device 102 can be transferred to and/or emitted by the display screen 106. As a result, the user may feel the heat when touching the display screen 106.

In the example of FIG. 1, one or more properties of the electronic device 102 can be adjusted during use of the stylus 104 with the device 102 to reduce power consumption of the device 102. As discussed above, the touch control circuitry 112 detects a position of the touch input(s) on the display screen 106 based on signals output by the display screen touch sensor(s) 110. During use of the stylus 104 (and/or, in instances, while providing touch input(s) with finger(s)), at least a portion of the user's hand and/or arm (e.g., palm, wrist, a side of the user's hand, a portion of the user's forearm) may contact (e.g., rest on) the display screen 106. The contact between portion(s) of the user's hand(s) and/or arm(s) and the display screen 106 can be detected as touch event(s) by the display screen touch sensor(s) 110 and transmitted to the touch control circuitry 112.

The example touch control circuitry 112 of FIG. 1 recognizes that certain touch event(s) detected by the display screen touch sensor(s) 110 are not intended touch input(s) by the user based on, for example, a location, a size, etc. of the touch input(s) relative to the display screen 106. In particular, the touch control circuitry 112 executes palm rejection algorithm(s) to differentiate between (a) intended touch inputs by the user via the stylus 104 (and/or finger(s) of the user) and (b) touch inputs due to contact between the user's hand(s) and/or arm(s) and the display screen 106 that do not represent intended touch input(s) by the user. The touch control circuitry 112 of FIG. 1 refrains from communicating the touch event(s) associated with the contact of portion(s) of the user's hand(s) and/or arm(s) on the display screen 106 to, for example, the processor circuitry 114. As a result, the touch control circuitry 112 prevents, for instance, an unintended output by a user application 120 due to the user resting his or her hand(s) and/or arm(s) on the display screen 106 while using the stylus 104. Thus, the touch inputs due to the user resting portion(s) of his or her hand(s) and/or arm(s) on the display screen 106 while using the stylus 104 are effectively rejected or ignored.

In the example of FIG. 1, the touch control circuitry 112 transmits location data for the unintended touch event(s) to pixel control circuitry 144 of the electronic device 102. The unintended touch event location data includes the location(s) of the touch inputs detected by the display screen touch sensor(s) 110 but rejected by the touch control circuitry 112 as unintended touch input(s) based on execution of the palm rejection algorithm(s). The unintended touch event location data can define, for example, area(s) of the display screen 106 on which a portion (e.g., palm, wrist) of the user's hand holding the stylus 104 is resting, area(s) of the display screen 106 on which portion(s) of the opposite hand of the user are resting, etc.

The example pixel control circuitry 144 analyzes the unintended touch event location data to determine (e.g., predict, estimate) area(s) of the display screen 106 that are covered by the user's hand(s) and/or arm(s). For example, the pixel control circuitry 144 predicts a shape of the portion(s) of the user's hand(s) and/or arm(s) in contact with the display screen 106 based on the locations of the rejected touch events identified by the touch control circuitry 112. The pixel control circuitry 144 generates a map (e.g., a bitmap) that identifies area(s) of the display screen 106 covered or substantially covered by the user's hand(s) and/or arm(s) based on the predicted shape(s) of the portion(s) of the hand(s) and/or arm(s) and the location(s) of the unintended or rejected touch event(s).

The pixel control circuitry 144 uses the map to identify the pixels 108 located within the area(s) of the display screen 106 that are covered or substantially covered by the user's hand(s) and/or arm(s). Because portion(s) of the user's hand(s) and/or arm(s) are covering area(s) of the display screen 106, those area(s) are not visible or not substantially visible to the user. Thus, the pixel control circuitry 144 determines that the pixels 108 within the covered display screen area(s) can be turned off and/or dimmed.

In some examples, the pixel control circuitry 144 is implemented by the timing controller circuitry 130. In some examples, the pixel control circuitry 144 is implemented by dedicated circuitry separate from the timing controller circuitry 130. In some examples, the electronic device 102 is a laptop and the pixel control circuitry 144 is implemented by processor circuitry located in a lid of the laptop that carries the display panel 105 (e.g., to reduce latency as compared to if the pixel control circuitry 144 was implemented by the (e.g., main) processor circuitry 114). However, in some examples, the pixel control circuitry 144 is implemented by the (e.g., main) processor circuitry 114 of the electronic device 102. In examples in which the pixel control circuitry 144 is implemented separate from the timing controller circuitry 130, the pixel control circuitry 144 is in communication with the timing controller circuitry 130 via one or more communication pathways and/or protocols.

The pixel control circuitry 144 outputs instructions to cause the selected ones of the pixels 108 located within the covered or substantially covered display screen area(s) to be turned off or dimmed to decrease a brightness of the covered area(s) of the display screen 106 (and, thus, conserve power). The instructions can be implemented by, for instance, the timing controller circuitry 130 and the display driver control circuitry 132. In examples in which the display panel 105 includes the backlight 109, the pixel control circuitry 144 can generate instructions to cause the backlight 109 to dim or turn off for the portion(s) of the display screen 106 covered or substantially covered by the user's hand(s) and/or arm(s).

The pixel control circuitry 144 tracks changes in the area(s) of the display screen 106 that are covered by portion(s) of the user's hand(s) and/or arm(s) based on the unintended touch event location data received from the touch control circuitry 112 over time. The changes in the covered area(s) can be due to, for instance, movement of the user's hand(s) during use of the stylus 104. The pixel control circuitry 144 maintains and/or adjusts the pixels 108 that are turned off or dimmed based on the changes in the location(s) of the covered area(s) of the display screen 106. In some examples, the pixel control circuitry 144 causes the pixel(s) 108 that were previously turned off or dimmed to turn on or increase brightness based on movement of the user's hand(s) and/or arm(s) relative to the display screen 106 and, thus, corresponding changes in the covered area(s) and visible area(s) of the display screen 106.

In some examples, the pixel control circuitry 144 predicts movement of the user's hand(s) and/or arm(s) relative to the display screen 106 over time. The pixel control circuitry 144 can predict the movement(s) based on for example, current position(s) of the user's hand(s) and/or arm(s), a type of user input provided via the display screen 106 (e.g., using the stylus 104 as a highlighter, using the stylus to execute a signature), content presented via the display screen 106 (e.g., a document, a drawing application, an article presented in a web browser application). In such examples, the pixel control circuitry 144 predicts area(s) of the display screen 106 that are likely to be covered by the user's hand(s) and/or arm(s). The pixel control circuitry 144 can use the predicted coverage area(s) of the display screen 106 to turn off or dim the pixels 108 in the predicted areas quickly based on the predicted movement(s). In some examples, the pixel control circuitry 144 uses the predicted movement(s) to identify movement(s) away from area(s) of the display screen 106 for which the pixels 108 have been turned off or dimmed and to cause the pixels 108 to turn on or brighten in area(s) of the display screen 106 being uncovered due to user movements.

In some examples, at least a portion of the user's hand(s) and/or arm(s) may be hovering over the display screen 106 while the user is holding the stylus 104. For example, the user may keep his or her wrist raised relative to the display screen 106 when writing with the stylist 104 instead of resting the wrist on the display screen 106. In some examples, the image sensor(s) 136 capture images of the user's hand(s) and/or arm(s) relative to the display screen 106. The pixel control circuitry 144 analyzes the image data to determine the area(s) of the display screen 106 over which the user's hand(s) and/or arm(s) are hovering. Based on the predicted hover locations of the user's hand(s) and/or arm(s) relative to the display screen 106, the pixel control circuitry 144 estimates the shape(s) of the hovering portion(s) of the user's hand(s) and/or arm(s) and, thus, the corresponding area(s) of the display screen 106 that are covered, substantially covered, or likely to be covered by the user.

In some examples, the presence detection sensor(s) 138 can transmit signals indicative of a proximity of the user's hand(s) and/or arm(s) to the display screen 106 when the hand(s) and/or arm(s) are hovering over the display screen 106. Based on the signals from the presence detection sensor(s) 138, the pixel control circuitry 144 can determine (e.g., predict) the area(s) of the display screen 106 over which the user's hand(s) and/or arm(s) are hovering.

By turning off or reducing the brightness of the pixel(s) 108 within the area(s) of the display screen 106 covered by, substantially covered, or likely to be covered by the user's hand(s) and/or arm(s), the pixel control circuitry 144 reduces power consumption by the display panel 105 and, thus, the electronic device 102. In some examples, the electronic device 102 additionally or alternatively provides for power savings by monitoring a temperature of the display screen 106.

The display temperature control circuitry 146 of the electronic device 102 monitors a temperature of the display screen 106 (i.e., a skin or exterior surface of the display panel 105) during operation of the device 102 and, in particular, during use of the stylus 104 with the display screen 106. As disclosed herein, the display panel 105 includes the temperature sensor(s) 140 to measure a temperature of the display screen 106 on which the user's hand(s) and/or arm(s) may rest while providing touch input(s). Heat generated by the device 102 (e.g., by the (main) processor circuitry 114, the display driver control circuitry 132, the backlight 109) can be transmitted to the display screen 106. The heat can be felt by the user when the user's hand(s) and/or arm(s) are in contact with the exterior surface or skin defined by the display screen 106.

The display temperature control circuitry 146 compares a temperature of the display screen 106 to display temperature thresholds to determine if one or more operating properties or parameters of the device 102 should be adjusted to reduce a temperature of the display screen 106. In some examples, the display temperature control circuitry 146 performs the temperature threshold comparison in response to an indication from the touch control circuitry 112 that the user is interacting with the device 102 via the stylus 104 (e.g., based on detection of both intended touch events and unintended touch events by the touch control circuitry 112 at a given time or within a threshold amount of time). In such instances, because use of the stylus 104 may involve contact between the user's body and the display screen for a greater period of time than if the user were providing touch input(s) using his or her finger, the display temperature control circuitry 146 determines that the prolonged contact between the user and the display screen justifies the resources consumed by the device 102 to tune parameters of the device 102 (as compared to, for instance, quick taps using the finger(s)). In some examples, the display temperature control circuitry 146 identifies other instances of prolonged contact or likely prolonged contact between the user and the display screen 106, such as when the user is playing a game or reading an article or document on the display screen 106 (and may be resting his or her hand(s) and/or arm(s) on the display screen for at least some threshold duration of the interaction).

In examples in which the display temperature control circuitry 146 determines that the temperature of the display screen 106 exceeds the display temperature threshold, the display temperature control circuitry 146 generates instructions to adjust one or more parameters (e.g., operating parameter(s), display parameter(s), processing parameter(s)) of the device 102 to reduce the display screen temperature. In some examples, the display temperature control circuitry 146 generates instructions to adjust (e.g., reduce) a charging rate of a battery of the device 102 when the device 102 is connected to an alternating current (AC) source. In some examples, the display temperature control circuitry 146 generates instructions to adjust performance (e.g., a processing speed) of the (e.g., main) processor circuitry 114 of the device 102 without substantially impact to the operation of the device 102 (e.g., to avoid noticeable slower processing speeds by the user). For example, the display temperature control circuitry 146 can generate instructions to cause the (e.g., main) processor circuitry 114 throttle (e.g., adjust a clock speed and/or voltage to reduce an amount of heat generated). In some examples, the display temperature control circuitry 146 generates instructions to activate the fan(s) 142 of the device 102.

In some examples, the display temperature control circuitry 146 communicates with the pixel control circuitry 144 to cause pixel control circuitry 144 to adjust the pixels 108 in the area(s) of the display screen 106 that are covered, substantially covered, or likely to be covered by the user's hand(s) and/or the arm(s) during use of the stylus 104. For instance, in examples which the display screen temperature exceeds the display temperature threshold, the display temperature control circuitry 146 can generate instructions to cause the pixels 108 in the area(s) of the display screen 106 covered by the hand(s) and/or the arm(s) of the user to turn off to minimize generation of heat at the display screen 106. The display temperature control circuitry 146 can transmit the instructions with respect to the pixels 108 to, for instance, the pixel control circuitry 144. Thus, in examples disclosed herein, the pixels 108 can be adjusted to be turned off to reduce heat generated output via the display screen 106.

In some examples, the display temperature control circuitry 146 is implemented by processor circuitry separate from the central or main processor circuitry 114. In some examples, the electronic device 102 is a laptop and the display temperature control circuitry 146 is implemented by processor circuitry located in a lid of the laptop that carries the display panel 105 (e.g., to reduced latency as compared to if the display temperature control circuitry 146 was implemented by the (e.g., main) processor circuitry 114). However, in some examples, the display temperature control circuitry 146 is implemented by the (e.g., main) processor circuitry 114 of the electronic device 102.

In some examples, one or more of the pixel control circuitry 144 or the display temperature control circuitry 146 is implemented by instructions executed on processor circuitry of a wearable or non-wearable electronic device different than the electronic device 102 and/or on one or more cloud-based devices (e.g., one or more server(s), processor(s), and/or virtual machine(s)). In some examples, some of the analysis performed by the pixel control circuitry 144 and/or the display temperature control circuitry 146 is implemented by the pixel control circuitry 144 and/or the display temperature control circuitry 146 via a cloud-computing environment and one or more other parts of the analysis is implemented by one or more of the dedicated logic circuitry of the electronic device 102, the processor circuitry 114, the touch control circuitry 112, the timing controller circuitry 130, and/or the processor circuitry of a second electronic device.

Although shown as one device 102, any or all of the components of the electronic device 102 may be in separate housings and, thus, the electronic device 102 may be implemented as a collection of two or more electronic devices. In other words, the electronic device 102 may include more than one physical housing. For example, the logic circuitry (e.g., the processor circuitry 114) along with support devices such as the one or more storage devices 122, a power supply 124, etc. may be a first electronic device contained in a first housing of, for example, a desktop computer, and the display screen 106 and the touch sensor(s) 110 may be contained in a second housing separate from the first housing. The second housing may be, for example, a display housing. Similarly, the user input device(s) 116 (e.g., microphone(s), camera(s), keyboard(s), touchpad(s), mouse, etc.) and/or the output device(s) 127 (e.g., speaker(s)) may be carried by the first housing, by the second housing, and/or by any other number of additional housings. Thus, although FIG. 1 and the accompanying description refer to the components as components of the electronic device 102, these components can be arranged in any number of manners with any number of housings of any number of electronic devices.

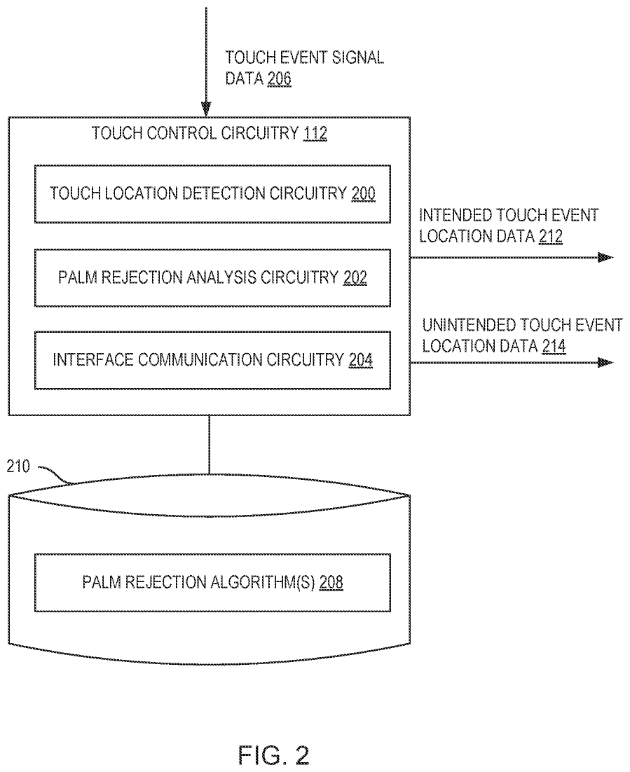

FIG. 2 is a block diagram of the example touch control circuitry 112 of FIG. 1 to distinguish between (a) touch event(s) on the display screen 106 of the device 102 of FIG. 1 that represent intentional user input(s) to the device 102 meant to invoke a response from the device 102 and (b) touch event(s) resulting from the user resting a portion of his or her body (e.g., hand(s) and/or arm(s)) on the display screen 106 that are not representative of intentional user inputs to the device 102 and, thus, referred to herein as unintended touch event(s)). The touch control circuitry 112 of FIG. 2 may be instantiated (e.g., creating an instance of, bring into being for any length of time, materialize, implement, etc.) by processor circuitry such as a central processing unit executing instructions. Additionally or alternatively, the touch control circuitry 112 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

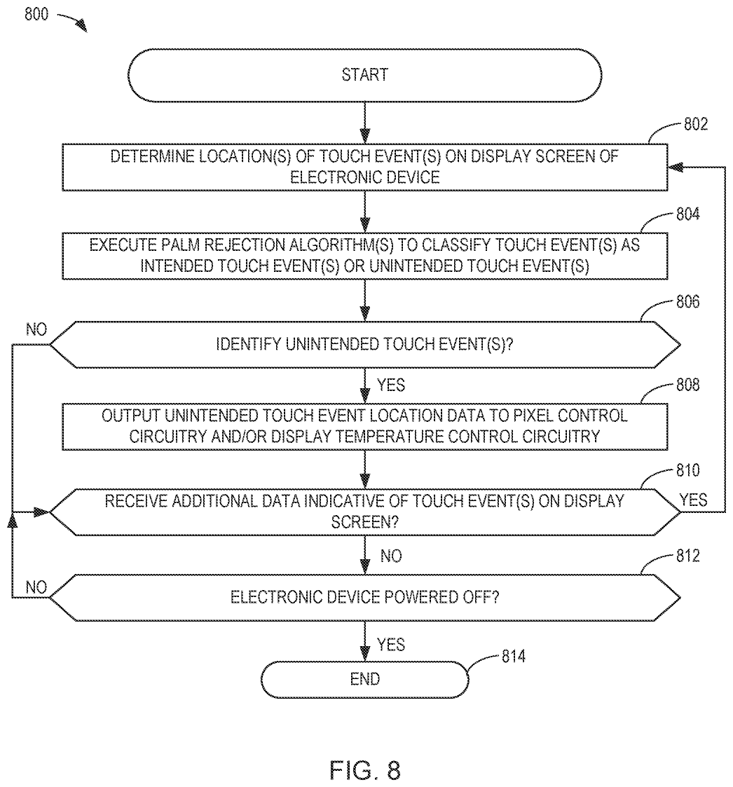

The example touch control circuitry 112 of FIG. 2 includes touch location detection circuitry 200, palm rejection analysis circuitry 202, and interface communication circuitry 204. In some examples, the touch location detection circuitry 200 is instantiated by processor circuitry executing touch location detection instructions and/or configured to perform operations such as those represented by the flowchart of FIG. 8. In some examples, the palm rejection analysis circuitry 202 is instantiated by processor circuitry executing palm rejection analysis instructions and/or configured to perform operations such as those represented by the flowchart of FIG. 8. In some examples, the interface communication circuitry 204 is instantiated by processor circuitry executing interface communication instructions and/or configured to perform operations such as those represented by the flowchart of FIG. 8.

The touch location detection circuitry 200 analyzes signal data 206 generated by the display screen touch sensor(s) 110 when the user's finger(s) or the stylus 104 touch the display screen 106. The touch location detection circuitry 200 identifies the locations of touch event(s) on the display screen 106 based on the touch event signal data 206 (e.g., location(s) where voltage change(s) were detected by the sense line(s) in the capacitive touch screen).

The palm rejection analysis circuitry 202 of the touch control circuitry 112 analyzes properties of the touch events detected by the display screen touch sensor(s) 110. In particular, the palm rejection analysis circuitry 202 determines if the touch events are indicative of intended touch input(s) or unintended touch event(s) due to the user resting his or her hand(s) and/or arm(s) on the display screen 106 while using, for instance, the stylus 104. The palm rejection analysis circuitry 202 executes one or more palm rejection algorithms 208 (e.g., neural network model(s)) to distinguish between intended touch events by the user and unintended touch events due to contact between portion(s) of the user's hand(s) and/or arm(s) and the display screen 106.

The palm rejection algorithm(s) 208 can consider variables such as a number and/or location(s) of the display screen touch sensor(s) 110 that detected the touch event(s), a size of the area of the display screen 106 associated with the touch event(s), etc. to distinguish between intended and unintended touch events. The palm rejection algorithm(s) 208 can recognize that touch event(s) detected by a threshold number of sensors 110 in proximity to one another can represent touch due to contact from the user's hand(s) and/or arm(s) on an area of the display screen 106 as compared to a touch event detected by a fewer number of sensor(s) 110, which can indicate contact with a tip of the stylus 104. The palm rejection algorithm(s) 208 can consider distances between two or more touch events on the display screen 106, which can represent, for instance, the occurrence of a touch event from the stylus 104 and a touch event due to contact from the user's hand(s) and/or arm(s) at substantially the same time. The palm rejection algorithm(s) 208 are stored in a database 210. In some examples, the touch control circuitry 112 includes the database 210. In some examples, the database 210 is located external to the touch control circuitry 112 in a location accessible to the touch control circuitry 112 as shown in FIG. 2.

As a result of the execution of the palm rejection algorithm(s) 208, the palm rejection analysis circuitry 202 classifies the touch event(s) as intended touch event(s) or unintended touch event(s). The palm rejection analysis circuitry 202 causes intended touch location data 212 to be output to, for instance, the processor circuitry 114 of the device 102 via the interface communication circuitry 204. The intended touch location data 212 includes location(s) of the touch event(s) classified as intended touch event(s), which can represent, for instance, user input(s) to one of the applications 120 installed on the device 102.

In the example of FIG. 2, the palm rejection analysis circuitry 202 outputs unintended touch event location data 214 for transmission to the pixel control circuitry 144 and/or the display temperature control circuitry 146 of the device 102. The unintended touch event location data 214 includes the locations(s) of the touch event(s) classified as unintended touch event(s) that may represent touch due to contact of the user's hand(s) and/or arm(s) with the display screen 106 while using the stylus 104. As disclosed herein, the pixel control circuitry 144 uses the unintended touch event location data 214 to identify the pixels 108 of the display screen 106 that may be eligible to be turned off, dimmed, or made static because an area of the display screen 106 including the pixels 108 is covered by the user's hand(s) and/or arm(s).

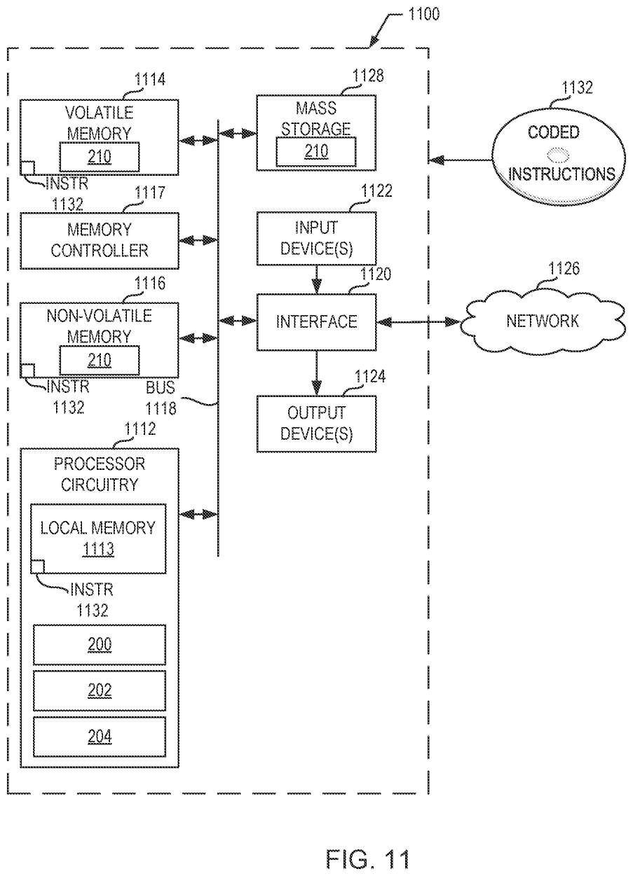

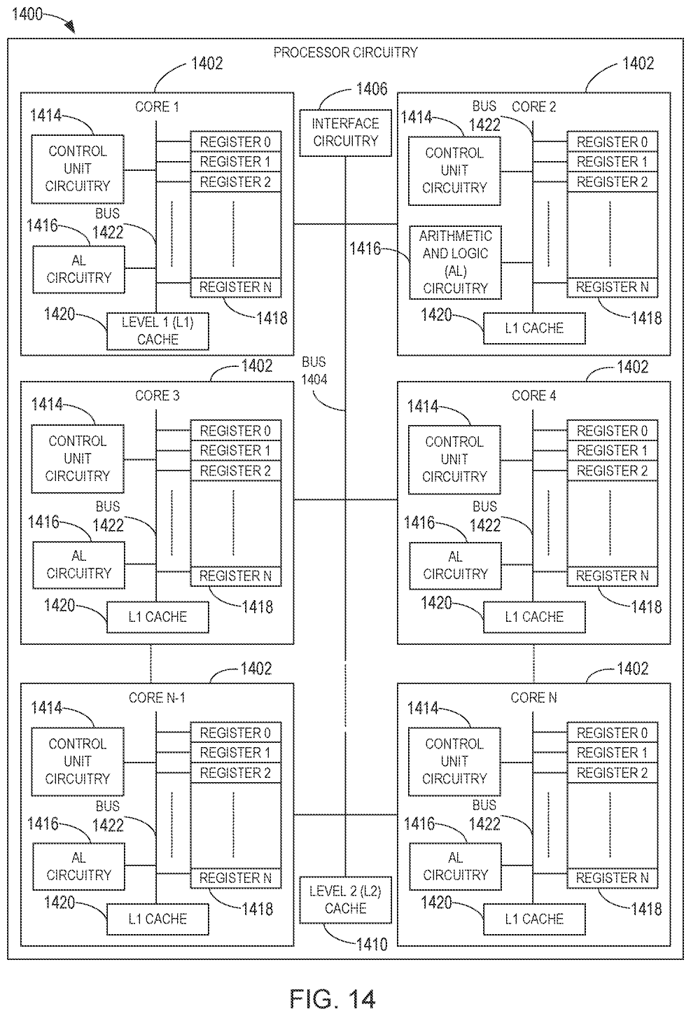

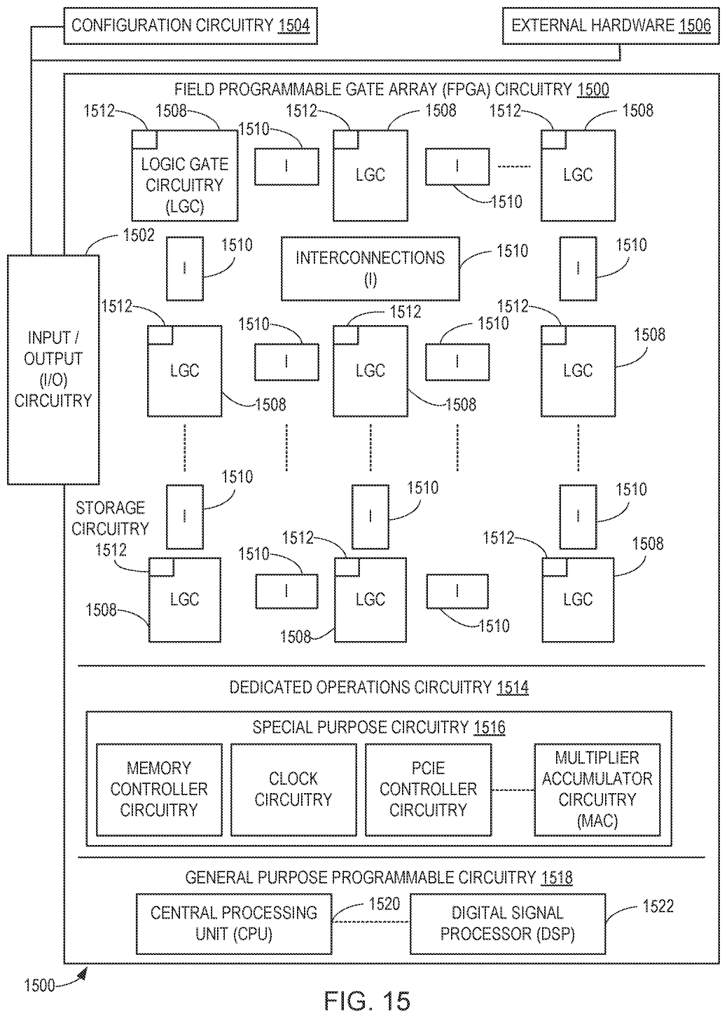

In some examples, the touch control circuitry 112 includes means for detecting a touch event location. For example, the means for detecting a touch event location may be implemented by the touch location detection circuitry 200. In some examples, the touch location detection circuitry 200 may be instantiated by processor circuitry such as the example processor circuitry 1112 of FIG. 11. For instance, the touch location detection circuitry 200 may be instantiated by the example microprocessor 1400 of FIG. 14 executing machine executable instructions such as those implemented by at least block 802 of FIG. 8. In some examples, the touch location detection circuitry 200 may be instantiated by hardware logic circuitry, which may be implemented by an ASIC, XPU, or the FPGA circuitry 1500 of FIG. 15 structured to perform operations corresponding to the machine readable instructions. Additionally or alternatively, the touch location detection circuitry 200 may be instantiated by any other combination of hardware, software, and/or firmware. For example, the touch location detection circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the touch control circuitry 112 includes means for performing palm rejection analysis. For example, the means for performing palm rejection analysis may be implemented by the palm rejection analysis circuitry 202. In some examples, the palm rejection analysis circuitry 202 may be instantiated by processor circuitry such as the example processor circuitry 1112 of FIG. 11. For instance, the palm rejection analysis circuitry 202 may be instantiated by the example microprocessor 1400 of FIG. 14 executing machine executable instructions such as those implemented by at least blocks 804, 806 of FIG. 8. In some examples, the palm rejection analysis circuitry 202 may be instantiated by hardware logic circuitry, which may be implemented by an ASIC, XPU, or the FPGA circuitry 1500 of FIG. 15 structured to perform operations corresponding to the machine readable instructions. Additionally or alternatively, the palm rejection analysis circuitry 202 may be instantiated by any other combination of hardware, software, and/or firmware. For example, the palm rejection analysis circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the touch control circuitry 112 includes means for interfacing. For example, the means for interfacing may be implemented by the interface communication circuitry 204. In some examples, the interface communication circuitry 204 may be instantiated by processor circuitry such as the example processor circuitry 1112 of FIG. 11. For instance, the interface communication circuitry 204 may be instantiated by the example microprocessor 1400 of FIG. 14 executing machine executable instructions such as those implemented by at least blocks 808, 810 of FIG. 8. In some examples, the interface communication circuitry 204 may be instantiated by hardware logic circuitry, which may be implemented by an ASIC, XPU, or the FPGA circuitry 1500 of FIG. 15 structured to perform operations corresponding to the machine readable instructions. Additionally or alternatively, the interface communication circuitry 204 may be instantiated by any other combination of hardware, software, and/or firmware. For example, the interface communication circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the touch control circuitry 112 of FIG. 1 is illustrated in FIG. 2, one or more of the elements, processes, and/or devices illustrated in FIG. 2 may be combined, divided, re-arranged, omitted, eliminated, and/or implemented in any other way. Further, the example touch location detection circuitry 200, the example palm rejection analysis circuitry 202, the example interface communication circuitry 204, and/or, more generally, the example touch control circuitry 112 of FIG. 1, may be implemented by hardware alone or by hardware in combination with software and/or firmware. Thus, for example, any of the example touch location detection circuitry 200, the example palm rejection analysis circuitry 202, the example interface communication circuitry 204, and/or, more generally, the example touch control circuitry 112, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example touch control circuitry 112 of FIG. 1 may include one or more elements, processes, and/or devices in addition to, or instead of, those illustrated in FIG. 2, and/or may include more than one of any or all of the illustrated elements, processes, and devices.

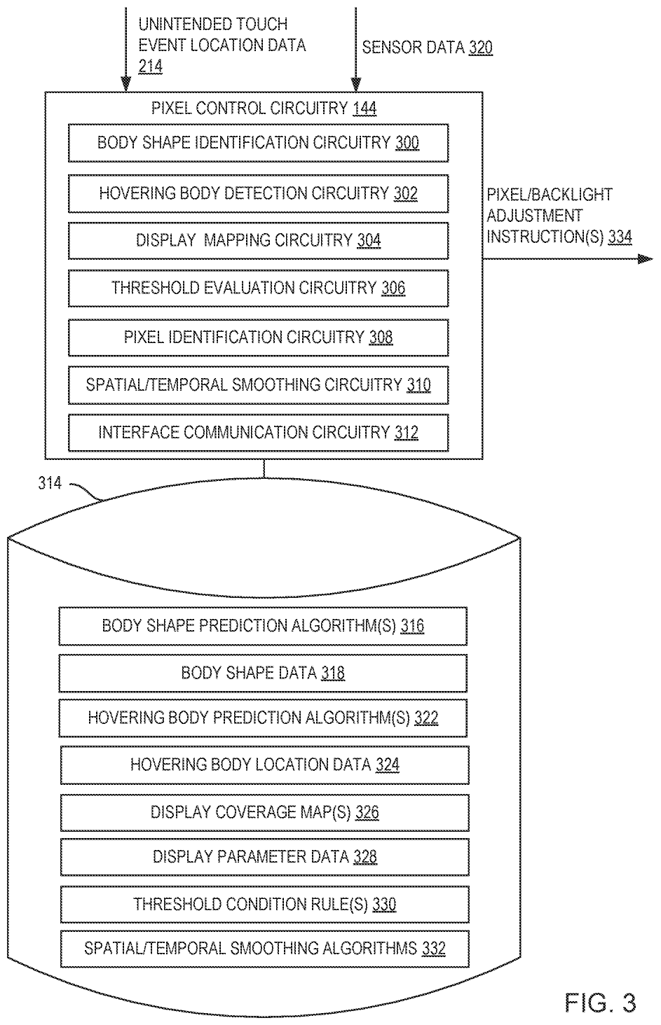

FIG. 3 is a block diagram of the example pixel control circuitry 144 to identify pixels 108 of the display screen 106 to be adjusted (e.g., turned off, dimmed, made static) due to a presence of portion(s) of the user's body (the user's hand(s) and/or arm(s)) covering or substantially covering area(s) of the display screen 106 while interacting with the device 102 using the stylus 104 (or, in some instances, providing touch input(s) using finger(s)). The pixel control circuitry 144 of FIG. 3 may be instantiated (e.g., creating an instance of, bring into being for any length of time, materialize, implement, etc.) by processor circuitry such as a central processing unit executing instructions. Additionally or alternatively, the pixel control circuitry 144 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

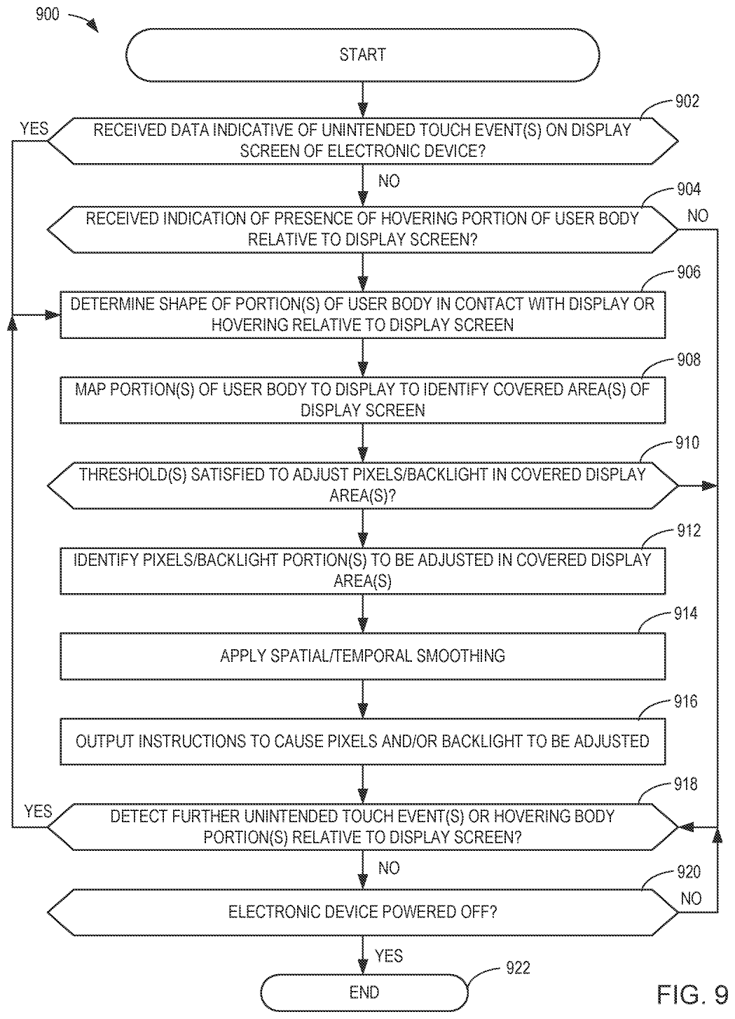

The example pixel control circuitry 144 of FIG. 3 includes body shape identification circuitry 300, hovering body detection circuitry 302, display mapping circuitry 304, threshold evaluation circuitry 306, pixel identification circuitry 308, spatial/temporal smoothing circuitry 310, and interface communication circuitry 312. In some examples, the body shape identification circuitry 300 is instantiated by processor circuitry executing body shape identification circuitry 300 instructions and/or configured to perform operations such as those represented by the flowchart of FIG. 9. In some examples, the hovering body detection circuitry 302 is instantiated by processor circuitry executing hovering body detection instructions and/or configured to perform operations such as those represented by the flowchart of FIG. 9. In some examples, the display mapping circuitry 304 is instantiated by processor circuitry executing display mapping instructions and/or configured to perform operations such as those represented by the flowchart of FIG. 9. In some examples, the threshold evaluation circuitry 306 is instantiated by processor circuitry executing threshold evaluation instructions and/or configured to perform operations such as those represented by the flowchart of FIG. 9. In some examples, the pixel identification circuitry 308 is instantiated by processor circuitry executing pixel identification instructions and/or configured to perform operations such as those represented by the flowchart of FIG. 9. In some examples, the spatial/temporal smoothing circuitry 310 is instantiated by processor circuitry executing spatial/temporal smoothing instructions and/or configured to perform operations such as those represented by the flowchart of FIG. 9. In some examples, the interface communication circuitry 312 is instantiated by processor circuitry executing interface communication instructions and/or configured to perform operations such as those represented by the flowchart of FIG. 9.

The pixel control circuitry 144 receives the unintended touch event location data 214 from the touch control circuitry 112 of FIGS. 1 and/or 2. The unintended touch event location data 214 can be stored in a database 314. In some examples, the pixel control circuitry 144 includes the database 314. In some examples, the database 314 is located external to the pixel control circuitry 144 in a location accessible to the pixel control circuitry 144 as shown in FIG. 3.

The body shape identification circuitry 300 analyzes the unintended touch event location data 214 to determine (e.g., predict) shape(s) of the portion(s) of the user's hand(s) and/or arm(s) in contact with (e.g., resting on) the display screen 106 and, thus, shape of area(s) of the display screen 106 covered, substantially covered, or likely to be covered by portion(s) the hand(s) and/or arm(s) of the user. For example, the body shape identification circuitry 300 can determine shape(s) of the portion(s) of the user's hand(s) and/or arm(s) in contact with the display screen 106 based on the locations of the unintended touch events on the display screen 106 identified by the touch control circuitry 112. The locations of the unintended touch events can define, for instance, the outline of the user's hand(s) and/or arm(s) in contact with the display screen 106, can identify starting and ending locations of the portion(s) of the hand(s) and/or arm(s) in contact with the display screen 106, can identify a width and/or length of the hand(s) and/or arm(s) in contact with the display screen 106, etc.

The body shape identification circuitry 300 can execute one or more body shape prediction algorithm(s) 316 to predict the shape(s) of the portion(s) of the user's hand(s) and/or arm(s) based on the unintended touch event location data 214. The body shape prediction algorithm(s) 316 can include neural network model(s). The neural network model(s) 316 can be trained using reference data including shapes or configurations of known positions of hand(s) and/or arm(s) when using a stylus or a pen, when performing writing motions, when writing on a surface such as a display, etc. The training data include data tracking movements of hand(s) and/or arm(s) of users when interacting with a display screen. The training data can include other types of data involving interactions between a user and a display screen that may or may not include use of a stylus, such as positions, movements, shapes, and/or configurations of a user's hands when playing a game on a display screen, when reading an article, etc., The body shape prediction algorithm(s) 316 are stored in the database 314.

Based on the execution of the body shape prediction algorithm(s) 316 and the location data in the unintended touch event location data 214, the body shape identification circuitry 300 predicts the shape(s) of the portion(s) of the user's hand(s) and/or arm(s) in contact with the display screen 106. In some examples, the body shape identification circuitry 300 interpolates the unintended touch event location data 214 to define an outline of the shape of the portion(s) of the user's hand(s) and/or arm(s) in contact with the display screen 106. The resulting shape(s) the portion(s) of the hand(s) and/or arm(s) as determined by the body shape identification circuitry 300 can be stored as body shape data 318 in the database 314.

As disclosed herein, in some examples, one or more portions of the user's hand(s) and/or arm(s) are not in contact with on the display screen 106 but are hovering over the display screen 106 such that the area(s) of the display screen 106 over which the hand(s) and/or arm(s) are hovering are not visible to the user. The example hovering body detection circuitry 302 of FIG. 3 detects the presence of hovering hand and/or arm portion(s) relative to the display screen 106 based on sensor data 320 from the image sensor(s) 136 and/or the presence detection sensor(s) 138 of the device 102. The hovering body detection circuitry 302 executes one or more hovering body shape prediction algorithm(s) 322 to identify the presence of the hovering body portion(s) relative to the display screen 106. In particular, the hovering body detection circuitry 302 predicts the location(s) of the hovering body portion(s) relative to the display screen 106. For example, the hovering body detection circuitry 302 can perform image analysis using image data from the image sensor(s) 136 and the hovering body shape prediction algorithm(s) 322 to identify the location(s) of the portion(s) of the hand(s) and/or arm(s) hovering over the display screen 106. In some examples, the hovering body detection circuitry 302 analyzes data from the presence detection sensor(s) 138 to predict the presence of the hovering body portion(s) relative to the display screen 106. The hovering body detection circuitry 302 generate hovering body location data 324 that is stored in the database 314.

The hovering body shape prediction algorithm(s) 322 can include neural network model(s) trained using reference data including, for instance, average distance(s) of hand(s) and/or arm(s) of user(s) from a display screen when user(s) are using a stylus, common shapes or configurations of the hand(s) and/or arm(s) when the hand(s)/arm(s) are in a hovering position, etc. The hovering body shape prediction algorithms(s) 322 are stored in the database 314.

The body shape identification circuitry 300 determines (e.g., predicts) the shape(s) of the portion(s) of the hand(s) and/or arm(s) hovering over the display screen 106 based on the location data of the hovering portions identified by the hovering body detection circuitry 302. The shape(s) of the hovering body portion(s) relative to the display screen 106 can be stored as the body shape data 318 in the database 314 In some examples, a portion of user's hand(s) and/or arm(s) may be touching the display screen 106 and a portion of the user's hand(s) and/or arm(s) may cover the display screen 106 but not touch the display screen 106. In such examples, the body shape identification circuitry 300 can predict the shape(s) of the portion(s) of the hand(s) and/or arm(s) covering, substantially covering, or likely to cover the display screen 106 based on the unintended touch event location data 214 and the location(s) of the hovering portion(s) identified by the hovering body detection circuitry 302.

In some examples, the body shape identification circuitry predicts movement(s) of the user's hand(s) and/or arm(s) relative to the display screen 106 and, thus, the predicted shape(s) of the area(s) of the display screen likely to be covered by the user's hand(s) and/or arm(s) due to the movement(s). For example, the body shape identification circuitry can execute the body shape prediction algorithm(s) 316 for the unintended touch location data 314 and/or previously generated body shape data 318. In some examples, the pixel control circuitry 144 obtains information about the data presented on the display screen (e.g., display frame(s) from the display control circuitry 128) to predict the expected movement(s) of the user's hand(s) and/or arm(s) relative to the display screen 106 and the corresponding shape(s) of the user's hand(s) and/or arm(s) in connection with the predicted movement(s).

The display mapping circuitry 304 of FIG. 3 accesses the predicted shape(s) of the portion(s) of the hand(s) and/or arm(s) in contact with or hovering over the display screen 106 (i.e., the body shape data 318) and location(s) of the portion(s) of the hand(s) and/or arm(s) relative to the display screen 106 (e.g., the unintended touch event location data 214, the hovering body location data 324). In some examples, the display mapping circuitry 304 accesses the predicted shape(s) of the user's hand(s) and/or arm(s) in connection with predicted movements by the user. The display mapping circuitry 304 creates a display coverage map 326 (e.g., a bitmap) identifying the area(s) of the display screen 106 covered, substantially covered, or likely to be covered by the user's hand(s) and/or arm(s). The display coverage map 326 identifies areas of the display screen 106 uncovered or likely to be uncovered due to, for instance, predicted user movements relative to the display screen 106 over time. The display mapping circuitry 304 correlates the location and shape data for the portions of the hand(s) and/or arm(s) in contact with or hovering over (or likely to be contact with or hovering over) the display screen 106 with display parameter data 328 for the display screen 106. The display parameter data 328 can define, for example, a size of the display screen 106, the locations of respective pixels 108 of the display screen 106, etc. The display coverage map(s) 326 can be stored in the database 314.

The threshold evaluation circuitry 306 of FIG. 3 determines whether the display coverage map(s) 326 satisfy one or more threshold condition rule(s) 330 such that the pixels 108 and/or backlight brightness within the area(s) of the display screen 106 that are covered, substantially covered, or likely to be covered by the user's hand(s) and/or arm(s) should be adjusted. For example, the threshold condition rule(s) 330 can define an amount of the display screen 106 that should be covered by the user's body (e.g., hand(s) and/or arm(s)) for the pixels 108 to be turned off or dimmed or the brightness of the backlight 109 to be adjusted. The threshold amounts can include, for instance 5% or 10% of the area of the display screen 106 that presents images. In some instance, if the amount of the covered area of the display screen 106 identified in the display coverage map 326 does not satisfy the threshold condition rule(s) 330, the threshold evaluation circuitry 306 determines that the power savings that would be obtained from turning off or dimming the pixels 108 or adjusting the backlight brightness in the area does not outweigh the resources consumed to cause the pixels 108 or the backlight 109 to be adjusted. Thus, because there would not be a substantial benefit to the power savings of the device 102, the threshold evaluation circuitry 306 determines that the pixels 108 and/or the backlight 109 should not be adjusted.

In some examples, the threshold condition rule(s) 330 define time thresholds for which portion(s) of the display screen 106 are covered, substantially covered, or likely to be covered to initiate the adjustments to the pixels 108 and/or the backlight 109. The threshold evaluation circuitry 306 can monitor display coverage maps 326 generated over time to predict if the user is interacting with the device 102 via the stylus 104 for a threshold period of time such that adjusting the pixels 108 and/or the backlight 109 would likely provide power savings at the device 102 (e.g., because the user is likely to cover area(s) of the display screen 106 for a threshold duration of time). In some examples, the threshold condition rule(s) 330 do not include time thresholds, but instead, indicate that the pixels 108 should be adjusted whenever the touch control circuitry 112 detects both intended touch event(s) and unintended touch event(s) on the display screen 106 at the same time or within a threshold amount of time. The threshold condition rule(s) 330 can be defined by user input(s) and stored in the database 314.

In examples in which the threshold evaluation circuitry 306 determines that the display coverage map(s) 326 satisfy the threshold condition rule(s) 330 with respect to amount(s) of the display screen 106 covered, substantially covered, or likely to be covered by the user hand(s) and/or arm(s) and/or the timing for which the area(s) are covered or are likely to be covered, the pixel identification circuitry 308 identifies the respective pixels 108 to be adjusted based on the display coverage map 326. In particular, the pixel identification circuitry 308 identifies the locations of the pixels 108 that are within the area(s) of the display screen 106 that are covered, substantially covered, or likely to be to covered by the user's hand(s) and/or arm(s) as indicated in the map 326. Because of the locations of the pixels 108 within the covered area(s) of the display screen 106, the pixels 108 are candidates to be adjusted (e.g., turned off, dimmed, or made static (i.e., a color emitted by the pixel 108 does not change)). In examples in which the display panel 105 of FIG. 1 includes the backlight 109, the pixel identification circuitry 308 can use the display coverage map(s) 326 to identify area(s) of the display screen 106 for which the brightness of the blacklight 109 should be adjusted.

In some examples the spatial/temporal smoothing circuitry 310 of FIG. 3 modifies the pixels 108 identified by the pixel identification circuitry 308 for adjustment to reduce the occurrence of artifacts on the display screen 106. Artifacts can occur when the pixels 108 that are turned off, dimmed, or made static extend beyond the area(s) of the display screen 106 corresponding to the portion(s) of the user's hand(s) and/or arm(s) that are covering or hovering over the display screen 106. In such instances, the some or all of the areas of the display screen 106 for which the pixels 108 have been turned off, dimmed, or made static may be visible to the user, which can disrupt the user's experience with the display screen 106 (e.g., by creating the appearance of black portion(s) on the display screen 106 that disrupt the content presented on the display screen 106). The spatial/temporal smoothing circuitry 310 applies one or more spatial and/or temporal smoothing algorithms 332 to determine if the pixels 108 identified by the pixel identification circuitry 308 should be adjusted.

The spatial and/or temporal smoothing algorithms 332 can account for arbitrary shapes of the portion(s) of the hand(s) and/or arm(s) covering or hovering over the display screen 106. The spatial and/or temporal smoothing algorithms 332 can account for quick or sudden movements by the user relative to the display screen 106 when using the stylus 104 to avoid latencies in adjusting the pixels 108, which could otherwise result in the area(s) of the display screen 106 including the pixels 108 that are turned off, dimmed, or made static being visible or partially visible to the user. The spatial/temporal smoothing circuitry 310 can adjust the pixels 108 identified for modification such, for instance, that the area(s) of the display screen 106 including adjusted pixels appear to have smooth edges (e.g., rather than the appearance of block or jagged lines). As a result, the spatial/temporal smoothing circuitry 310 reduces instances in which area(s) of the display screen 106 including the pixels 108 that are turned off, dimmed, or made static are visible or partially visible to the user. The spatial and/or temporal smoothing algorithms 332 can include neural network models trained to identify, for instance, arbitrary shapes of the hand(s) and/or arm(s) and corresponding area(s) of the display screen 106 to be adjusted. The spatial and/or temporal smoothing algorithms 332 can be stored in the database 410. In some examples, the spatial/temporal smoothing circuitry 310 applies the spatial and/or temporal smoothing algorithms 332 with respect to adjusting the brightness of the backlight 109.

The pixel identification circuitry 308 outputs pixel and/or backlight adjustment instruction(s) 334 via the interface communication circuitry 312. The pixel and/or backlight adjustment instruction(s) 334 can identify the particular ones of pixels 108 to be adjusted (e.g., dimmed, turned off, made static) based on the display coverage map 326 and, in some instances, the spatial and/or temporal smoothing performed by the spatial/temporal smoothing circuitry 310. The pixel and/or backlight adjustment instruction(s) 334 can include instructions with respect to adjustment of the brightness of the backlight 109. In examples in which the pixel control circuitry 144 is implemented by the timing controller circuitry 130, the pixel and/or backlight adjustment instruction(s) 334 can be transmitted to the display driver control circuitry 132. In examples in which the pixel control circuitry 144 is implemented by processor circuitry separate from the timing controller circuitry 130, the pixel control circuitry 144 outputs the pixel and/or backlight adjustment instruction(s) 334 for transmission to the timing controller circuitry 130 and the display driver control circuitry 132.

In some examples, the pixel identification circuitry 308 uses the map(s) 226 generated by the display mapping circuitry 304 including area(s) of the display screen 106 likely to be covered by the user's hand(s) and/or arm(s) based on predicted movement(s) of the user's hand(s) and/or arm(s) to increase responsive of the device 112 in adjusting the pixels 108 (e.g., increase a speed and/or efficiency at which the pixels 108 are adjusted as the user moves his or her hand(s) and/or arm(s) relative to the display screen 106). For example, the pixel control circuitry 144 can generate the pixel and/or backlight adjustment instruction(s) 334 based on the predicted area(s) of the display screen 106 likely to be covered. In such examples, the instruction(s) 334 generated based on the predicted user movement(s) can be used by the timing controller circuitry 130 and/or the display driver control circuitry 132 to quickly turn off or dim the pixels 108 when the user's movements correlate with the predicted movement(s) and, thus, the area(s) of the display screen identified as likely to be covered. Also, the instruction(s) 334 generated based on the predicted user movement(s) can be used by the timing controller circuitry 130 and/or the display driver control circuitry 132 to quickly turn back on or brighten pixels in the area(s) of the display screen 106 from which the user is expected to move away and, thus, uncover those area(s) of the display screen 106.

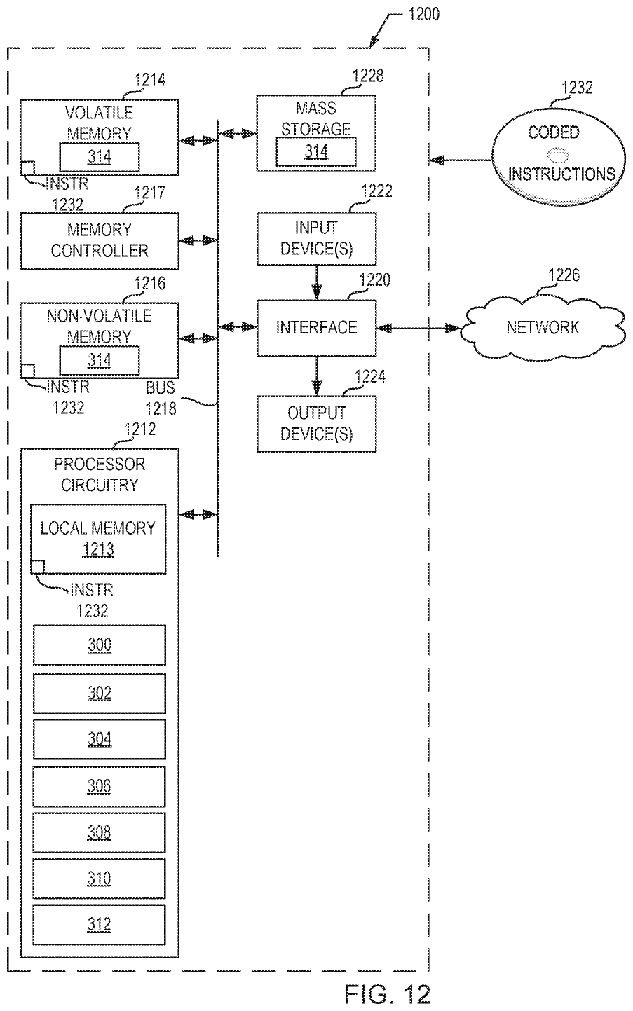

In some examples, the pixel control circuitry 144 includes means for identifying a shape of a portion of a body. For example, the means for identifying a shape of a portion of a body may be implemented by the body shape identification circuitry 300. In some examples, the body shape identification circuitry 300 may be instantiated by processor circuitry such as the example processor circuitry 1212 of FIG. 12. For instance, the body shape identification circuitry 300 may be instantiated by the example microprocessor 1400 of FIG. 14 executing machine executable instructions such as those implemented by at least blocks 902, 906, 918 of FIG. 9. In some examples, the body shape identification circuitry 300 may be instantiated by hardware logic circuitry, which may be implemented by an ASIC, XPU, or the FPGA circuitry 1500 of FIG. 15 structured to perform operations corresponding to the machine readable instructions. Additionally or alternatively, the body shape identification circuitry 300 may be instantiated by any other combination of hardware, software, and/or firmware. For example, the body shape identification circuitry 300 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the pixel control circuitry 144 includes means for detecting a hovering portion of a body. For example, the means for identifying a hovering portion of a body may be implemented by the hovering body detection circuitry 302. In some examples, the hovering body detection circuitry 302 may be instantiated by processor circuitry such as the example processor circuitry 1212 of FIG. 12. For instance, the hovering body detection circuitry 302 may be instantiated by the example microprocessor 1400 of FIG. 14 executing machine executable instructions such as those implemented by at least blocks 904, 918 of FIG. 9. In some examples, the hovering body detection circuitry 302 may be instantiated by hardware logic circuitry, which may be implemented by an ASIC, XPU, or the FPGA circuitry 1500 of FIG. 15 structured to perform operations corresponding to the machine readable instructions. Additionally or alternatively, the hovering body detection circuitry 302 may be instantiated by any other combination of hardware, software, and/or firmware. For example, the hovering body detection circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the pixel control circuitry 144 includes means for generating a display coverage map. For example, the means for generating a display coverage map may be implemented by the display mapping circuitry 304. In some examples, the display mapping circuitry 304 may be instantiated by processor circuitry such as the example processor circuitry 1212 of FIG. 12. For instance, the display mapping circuitry 304 may be instantiated by the example microprocessor 1400 of FIG. 14 executing machine executable instructions such as those implemented by at least block 908 of FIG. 9. In some examples, the display mapping circuitry 304 may be instantiated by hardware logic circuitry, which may be implemented by an ASIC, XPU, or the FPGA circuitry 1500 of FIG. 15 structured to perform operations corresponding to the machine readable instructions. Additionally or alternatively, the display mapping circuitry 304 may be instantiated by any other combination of hardware, software, and/or firmware. For example, the display mapping circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the pixel control circuitry 144 includes means for evaluating thresholds. For example, the means for evaluating thresholds may be implemented by the threshold evaluation circuitry 306. In some examples, the threshold evaluation circuitry 306 may be instantiated by processor circuitry such as the example processor circuitry 1212 of FIG. 12. For instance, the threshold evaluation circuitry 306 may be instantiated by the example microprocessor 1400 of FIG. 14 executing machine executable instructions such as those implemented by at least block 910 of FIG. 9. In some examples, the threshold evaluation circuitry 306 may be instantiated by hardware logic circuitry, which may be implemented by an ASIC, XPU, or the FPGA circuitry 1500 of FIG. 15 structured to perform operations corresponding to the machine readable instructions. Additionally or alternatively, the threshold evaluation circuitry 306 may be instantiated by any other combination of hardware, software, and/or firmware. For example, the threshold evaluation circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the pixel control circuitry 144 includes means for identifying pixels. For example, the means for identifying pixels may be implemented by the pixel identification circuitry 308. In some examples, the pixel identification circuitry 308 may be instantiated by processor circuitry such as the example processor circuitry 1212 of FIG. 12. For instance, the pixel identification circuitry 308 may be instantiated by the example microprocessor 1400 of FIG. 14 executing machine executable instructions such as those implemented by at least block 912, 916 of FIG. 9. In some examples, the pixel identification circuitry 308 may be instantiated by hardware logic circuitry, which may be implemented by an ASIC, XPU, or the FPGA circuitry 1500 of FIG. 15 structured to perform operations corresponding to the machine readable instructions. Additionally or alternatively, the pixel identification circuitry 308 may be instantiated by any other combination of hardware, software, and/or firmware. For example, the pixel identification circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the pixel control circuitry 144 includes means for performing smoothing. For example, the means for performing smoothing may be implemented by the spatial/temporal smoothing circuitry 310. In some examples, the spatial/temporal smoothing circuitry 310 may be instantiated by processor circuitry such as the example processor circuitry 1212 of FIG. 12. For instance, the spatial/temporal smoothing circuitry 310 may be instantiated by the example microprocessor 1400 of FIG. 14 executing machine executable instructions such as those implemented by at least block 914 of FIG. 9. In some examples, the spatial/temporal smoothing circuitry 310 may be instantiated by hardware logic circuitry, which may be implemented by an ASIC, XPU, or the FPGA circuitry 1500 of FIG. 15 structured to perform operations corresponding to the machine readable instructions. Additionally or alternatively, the spatial/temporal smoothing circuitry 310 may be instantiated by any other combination of hardware, software, and/or firmware. For example, the spatial/temporal smoothing circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the pixel control circuitry 144 includes means for interfacing. For example, the means for interfacing may be implemented by the interface communication circuitry 312. In some examples, the interface communication circuitry 312 may be instantiated by processor circuitry such as the example processor circuitry 1212 of FIG. 12. For instance, the interface communication circuitry 312 may be instantiated by the example microprocessor 1400 of FIG. 14 executing machine executable instructions such as those implemented by at least block 916 of FIG. 9. In some examples, the interface communication circuitry 312 may be instantiated by hardware logic circuitry, which may be implemented by an ASIC, XPU, or the FPGA circuitry 1500 of FIG. 15 structured to perform operations corresponding to the machine readable instructions. Additionally or alternatively, the interface communication circuitry 312 may be instantiated by any other combination of hardware, software, and/or firmware. For example, the interface communication circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the pixel control circuitry 144 of FIG. 1 is illustrated in FIG. 3, one or more of the elements, processes, and/or devices illustrated in FIG. 3 may be combined, divided, re-arranged, omitted, eliminated, and/or implemented in any other way. Further, the example body shape identification circuitry 300, the example hovering body detection circuitry 302, the example display mapping circuitry 304, the example threshold evaluation circuitry 306, the example pixel identification circuitry 308, the example spatial/temporal smoothing circuitry 310, the example interface communication circuitry 312, and/or, more generally, the example pixel control circuitry 144 of FIG. 1, may be implemented by hardware alone or by hardware in combination with software and/or firmware. Thus, for example, any of the example body shape identification circuitry 300, the example hovering body detection circuitry 302, the example display mapping circuitry 304, the example threshold evaluation circuitry 306, the example pixel identification circuitry 308, the example spatial/temporal smoothing circuitry 310, the example interface communication circuitry 312, and/or, more generally, the example pixel control circuitry 144, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example pixel control circuitry 144 of FIG. 1 may include one or more elements, processes, and/or devices in addition to, or instead of, those illustrated in FIG. 3, and/or may include more than one of any or all of the illustrated elements, processes, and devices.

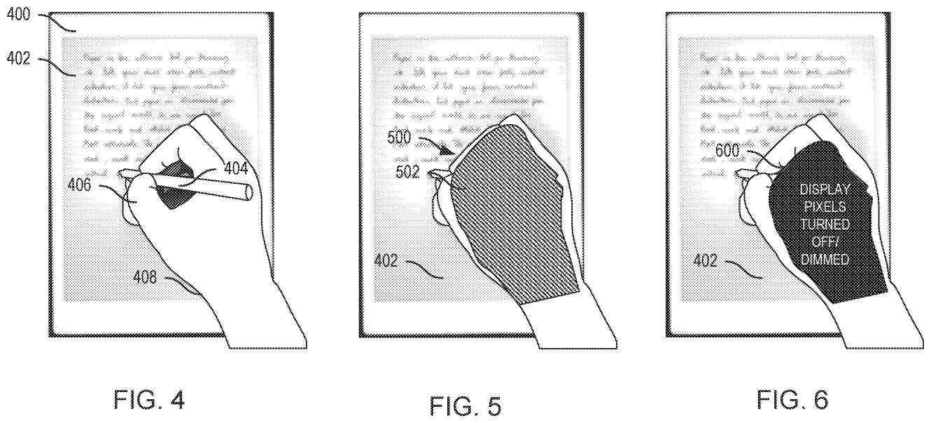

FIG. 4 illustrates an example an example electronic device 400 (e.g., the electronic device 102 of FIG. 1) including a display screen 402 (e.g., the display screen 106 of FIG. 1). As shown in FIG. 4, a user is interacting with the device 400 by providing input(s) via a stylus 404 held by a hand 406 of the user. Portions of the user's hand 406 and arm 408 (e.g., wrist) is resting on (e.g., in contact with) the display screen 106 as the user interacts with the device 400 via the stylus 404.

FIG. 5 illustrates an example display coverage map 500 generated by the display mapping circuitry 304 based on the portions of the hand 406 and the arm 408 of the user resting on the display screen 402 of FIG. 4. As disclosed herein, the body shape identification circuitry 300 estimates a shape of the portions of the hand 406 and the arm 408 covering the display screen 402. The display cover map 500 identifies an area 502 of the display screen 406 covered by the portions of the hand 406 and the arm 408 based on the (e.g., predicted) shape of the portions of the hand 406 and the arm 408 of the user covering the display screen 402.

FIG. 6 illustrates an adjusted area 600 of the display screen 402 of FIG. 4 including pixels that have been turned off or dimmed to conserve power in view of the user's hand 406 and arm 408 covering of a portion the display screen 402. The pixel identification circuitry 308 identifies the pixels located within the area 502 of the display screen 402 covered by the portion(s) of the hand 406 and the arm 408 based on the display coverage map 500. In some examples, spatial/temporal smoothing circuitry 310 adjusts the selected pixels to provide for smoothing of the adjusted area 600 including the pixels that are turned off or dimmed to reduce artifacts on the display screen 402 (e.g., pixels of the display screen 402 that are turned off but visible to the user). For instance, in the example of FIG. 6, the adjusted area 600 including the pixels to be turned off is smaller than the area 502 identified in the display coverage map 500 of FIG. 5 to prevent artifacts. The display driver control circuitry 132 of the device 400 causes the selected ones of the pixels to turn off. Because the adjusted area 600 of the display screen 106 is covered by the hand 406 and the arm 408 of the user, the adjusted area 600 is not visible to the user. Thus, power savings can be provided without disrupting the user's viewing experience on the display screen 402.

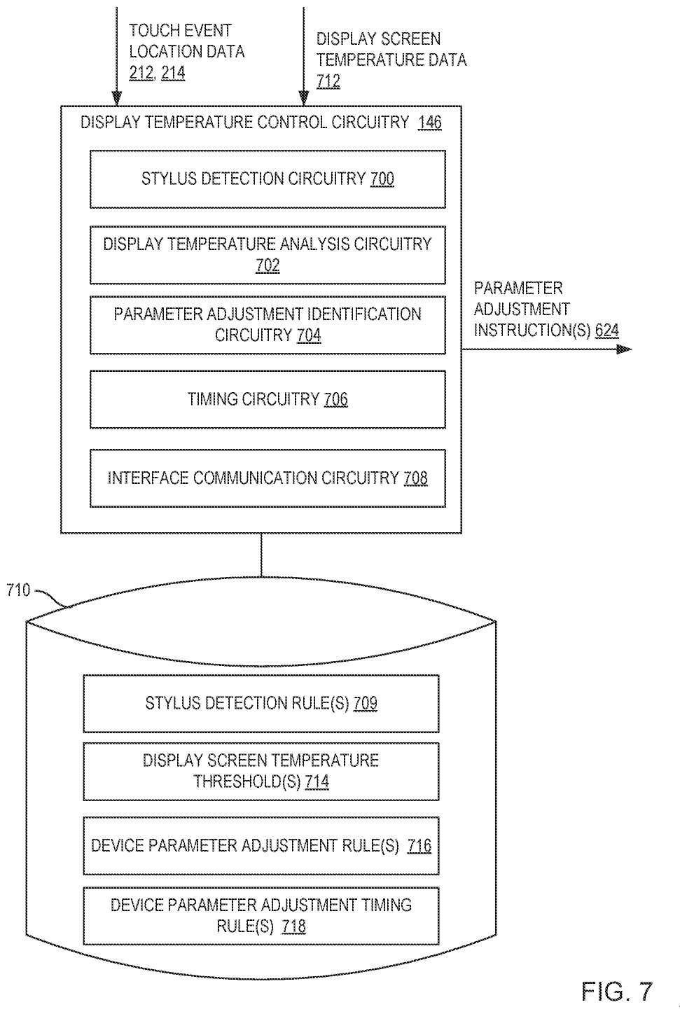

FIG. 7 is a block diagram of the example display temperature control circuitry 146 of FIG. 1 to adjust one or more parameter(s) (e.g., operating parameter(s), processing parameter(s), display parameter(s)) of the electronic device 102 of FIG. 1 to maintain a temperature of the display screen 106 (i.e., a skin or exterior surface of the display panel 105) within a threshold temperature range while a user is interacting with the device 102 using the stylus 104 (and/or in, in some instances, using his or her finger(s) to provide touch input(s)). The display temperature control circuitry 146 of FIG. 7 may be instantiated (e.g., creating an instance of, bring into being for any length of time, materialize, implement, etc.) by processor circuitry such as a central processing unit executing instructions. Additionally or alternatively, the display temperature control circuitry 146 of FIG. 7 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 7 may, thus, be instantiated at the same or different times. Some or all of the circuitry may be instantiated, for example, in one or more threads executing concurrently on hardware and/or in series on hardware. Moreover, in some examples, some or all of the circuitry of FIG. 7 may be implemented by microprocessor circuitry executing instructions to implement one or more virtual machines and/or containers.

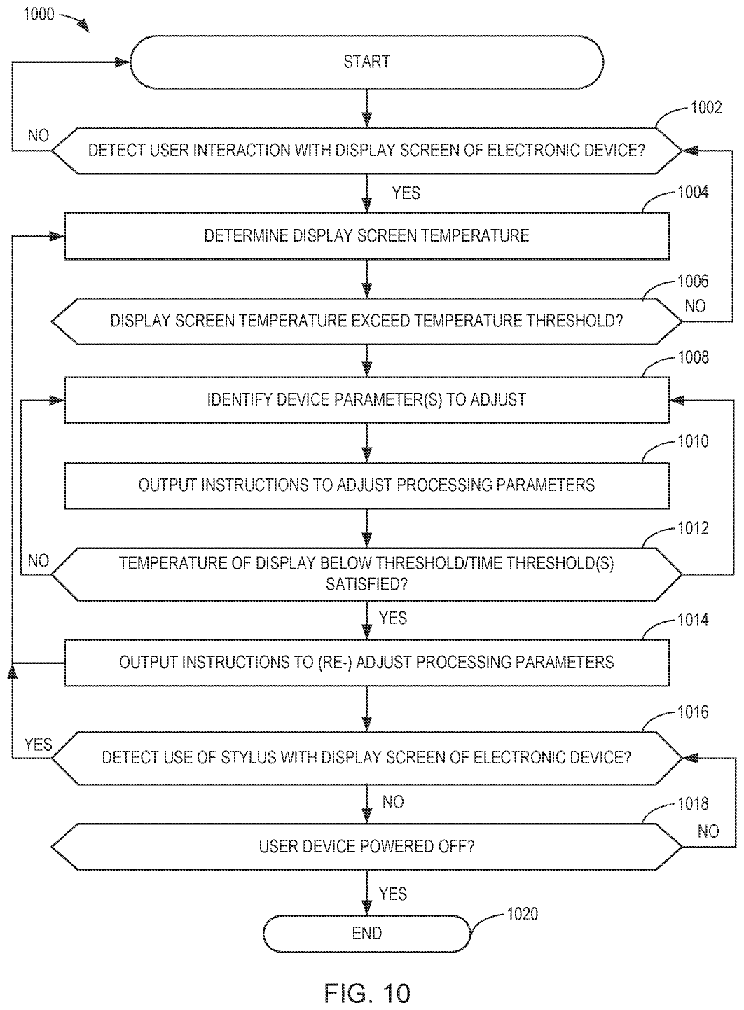

The example display temperature control circuitry 146 of FIG. 7 includes stylus detection circuitry 700, display temperature analysis circuitry 702, parameter adjustment identification circuitry 704, timing circuitry 706, and interface communication circuitry 708. In some examples, the stylus detection circuitry 700 is instantiated by processor circuitry executing stylus detection instructions and/or configured to perform operations such as those represented by the flowchart of FIG. 10. In some examples, the display temperature analysis circuitry 702 is instantiated by processor circuitry executing display temperature analysis instructions and/or configured to perform operations such as those represented by the flowchart of FIG. 10. In some examples, the parameter adjustment identification circuitry 704 is instantiated by processor circuitry executing parameter adjustment identification instructions and/or configured to perform operations such as those represented by the flowchart of FIG. 10. In some examples, the timing circuitry 706 is instantiated by processor circuitry executing timing instructions and/or configured to perform operations such as those represented by the flowchart of FIG. 10. In some examples, the interface communication circuitry 708 is instantiated by processor circuitry executing interface communication instructions and/or configured to perform operations such as those represented by the flowchart of FIG. 10.

In some examples, the stylus detection circuitry 700 of FIG. 7 identifies (e.g., predicts) use of the stylus 104 (or other user interaction(s)) in connection with the display screen 106. In examples in which the stylus detection circuitry 700 detects use of the stylus 104 (or other user interaction(s)), the stylus detection circuitry 700 can communicate with the display temperature analysis circuitry 702 to cause the display temperature analysis circuitry 702 to monitor the temperature of the display screen 106. The detection of use of the stylus 104 can serve as a trigger to initiate the display temperature monitoring by the display temperature control circuitry 146 because use of the stylus 104 can indicate that contact between a portion of a body of the user (e.g., the user's hand(s) and/or arm(s)) and the display screen 106 (e.g., an exterior surface) may satisfy a time duration threshold. Thus, there is an increased likelihood that user feels heat emitted by the display screen 106 during use of the stylus 104.

The stylus detection circuitry 700 can detect use of stylus 104 based on the generation of intended and/or unintended touch event location data 212, 214 by the touch control circuitry 112 of the device 102 and stylus detection rule(s) 709. For instance, the stylus detection rule(s) 709 can indicate that the detection of both intended and unintended touch events on the display screen 106 by the touch control circuitry 112 within a threshold amount of time indicates stylus usage. In some examples, the stylus detection circuitry 700 detects stylus usage based on data 212 from the touch control circuitry 112 indicating that intended touch events have been detected and data from the pixel control circuitry 144 indicating that portion(s) of the hand(s) and/or arm(s) of the user are hovering over the display screen 106, which can indicate potential future contact events between the user and the display screen 106. The stylus detection rule(s) 709 can be defined based on user inputs and stored in a database 710. In some examples, the display temperature control circuitry 146 includes the database 710. In some examples, the database 710 is located external to the display temperature control circuitry 146 in a location accessible to the display temperature control circuitry 146 as shown in FIG. 7.

In some examples, the stylus detection circuitry 700 identifies other instances of contact between the user and the display screen 106 based on the touch event data 212, 214 and/or data from the pixel control circuitry 144. For instance, the stylus detection circuitry 700 can detect interactions between the user and the display screen 106 such as when the user is playing a game or reading an article or document on the display screen 106. The stylus detection circuitry 700 can detect that the user is resting his or her hand(s) and/or arm(s) on the display screen for a threshold duration of time such that the user may experience heat emitted by the display screen 106. Thus, the example display temperature control circuitry 146 is not limited to stylus usage.

The temperature sensor(s) 140 of the display panel 105 output signals indicative of a temperature of the display screen 106 over time. Display screen temperature data 712 corresponding to the signals generated by the temperature sensor(s) 140 can be stored in the database 710. In some examples, the display temperature control circuitry 146 receives alternating current (AC) data when the device 102 is electrically coupled to a charging source or direct current (DC) data when the device 102 is operating a battery charge. The AC and DC data can be stored in the database 710 for analysis by the display temperature control circuitry 146 with respect to power consumption by the device 102.

The display temperature analysis circuitry 702 determines a temperature of the display screen 106 based on the display screen temperature data 712. In examples in which the stylus detection circuitry 700 detects use of the stylus 104 or other user interaction(s) (and, thus, a likelihood of contact between the user and the display screen 106 that exceeds a time duration threshold), the display temperature analysis circuitry 702 performs a comparison of the display screen temperature to display screen temperature threshold(s) 714. The display screen temperature threshold(s) 714 can define temperature limits and/or ranges for the display screen 106 (i.e., the skin or exterior surface of the display panel 105) to account for instances in which portion(s) of the hand(s) and/or arm(s) of the user are in contact with the display screen 106 during, for instance, stylus usage. The display screen temperature threshold(s) 714 can be defined based on user inputs and stored in the database 710.

The display temperature analysis circuitry 702 monitors the temperature of the display screen 106 over time based on the sensor data 712. In examples in which the display temperature analysis circuitry 702 determines that the temperature of the display screen 106 satisfies or exceeds the display screen temperature threshold(s) 714, the parameter adjustment identification circuitry 704 identifiers one or more parameters (e.g., operating parameter(s), processing parameter(s), display parameter(s)) of the device 102 to adjust to reduce an amount of heat generated by the device 102 and, thus, the amount of heat emitted by the display screen 106. The parameter adjustment identification circuitry 704 can select the parameters based on device parameter adjustment rule(s) 716. The device parameter adjustment rule(s) 716 can be defined based on user inputs and stored in the database 710.

The device parameter adjustment rule(s) 716 can define parameters of the device 102 to adjust to reduce power consumption and, thus heat generated by the device 102. In some examples, the device parameter adjustment rule(s) 716 indicate that when the temperature of the display screen 106 exceeds the display screen temperature threshold(s) 714, a charging rate of a battery of the device 102 should be reduced when the device 102 is electrically coupled to an alternating current source. In some examples, the device parameter adjustment rule(s) 716 indicate a speed of the fan(s) 142 of the device 102 should be increased to increase cooling of the device 102. In some examples, the device parameter adjustment rule(s) 716 can indicate the pixels 108 in the area(s) of the display screen 106 covered by the user's hand(s) and/or arm(s) should be turned off or dimmed, to reduce heat emitted via the display screen 106. In some examples, the device parameter adjustment rule(s) 716 can indicate that background application(s) should be closed to minimize the tasks performed by the (e.g., main) processor circuitry 114.

In some examples, the device parameter adjustment rule(s) 716 indicate that the (e.g., main) processor circuitry 114 should be throttled when the temperature of the display screen 106 exceeds the display screen temperature threshold(s) 714. In some examples, the device parameter adjustment rule(s) 716 define an amount of time for which the throttling should occur so as not to substantially affect performance of the (e.g., main) processor circuitry 114 and, thus, the user's experience with the device 102.

The device parameter adjustment rule(s) 716 can define hierarchies for selecting which parameter(s) of the device 102 should be adjusted based on, for example, the amount by which the temperature of the display screen 106 exceeds the temperature threshold(s) 714. For instance, the device parameter adjustment rule(s) 716 can indicate that when the temperature of the display screen 106 exceeds the temperature threshold(s) 714 by a first amount, the charging rate should be reduced. The device parameter adjustment rule(s) 716 can indicate that if the temperature of the display screen 106 has not decreased by a certain amount within a defined time period, then the (e.g., main) processor circuitry 114 should be throttled. Thus, the device parameter adjustment rule(s) 716 provide for dynamic tuning of the electronic device 102.

In some examples, the timing circuitry 706 of FIG. 7 determines if one or more timing thresholds are satisfied prior to the parameter adjustment identification circuitry 704 outputting the instructions to cause the selected parameter(s) to be adjusted. For example, the timing circuitry 706 can implement device parameter adjustment timing rule(s) 718. The device parameter adjustment timing rule(s) 718 can indicate that the use of the stylus 104 and/or the occurrence of unintended touch event(s) should be detected in connection with the display screen 106 for a threshold period of time before the parameter(s) of the device 102 are adjusted (e.g., before instructing the CPU to throttle). Thus, the timing circuitry 706 can balance resources to adjust the parameters against a length of time for which the stylus is being used with the display screen 106 (and, thus, a time for which contact between the user and the display screen 106 is likely).

The timing circuitry 706 can also monitor the time for which the parameters have been adjusted in view of changes to the temperature of the display screen 106 over time to determine if the parameter(s) should be adjusted further, should be returned to prior values, etc. For example, the device parameter adjustment timing rule(s) 718 can indicate a time duration for which the (e.g., main) processor circuitry 114 should be throttled to avoid slowing the processing speed of the device 102 to an extent that the user's experience with the device 102 is impacted (e.g., to avoid noticeable slower processing speeds). The device parameter adjustment timing rule(s) 718 can indicate a time duration for which the pixels 108 in the area(s) of the display screen 106 covered by the user's hand(s) and/or arm(s) should remain turned off to prevent artifacts on the display screen 106 in view of, for instance, movement of the user's hand(s). Put another way, the timing circuitry 706 monitors the duration of time for which the pixels 108 are turned off to prevent instances in which the portions of the display screen 106 with the pixels 108 turned off are visible to the user and, thus, disrupt viewing of content on the display screen 106.

The parameter adjustment identification circuitry 704 generates instruction(s) 624 for the selected parameter(s) to be adjusted and outputs the instruction(s) 624 for transmission via the interface communication circuitry 708. For example, the interface communication circuitry 708 can transmit instructions to the (e.g., main) processor circuitry 114 to cause the processor circuitry 114 to perform the throttling. In examples in which the parameter adjustment identification circuitry 704 determines that the pixels 108 should be adjusted (e.g., turned off, dimmed), the interface communication circuitry 708 can communicate the instructions 624 to the pixel control circuitry 144. In such examples, the pixel control circuitry 144 can identify the pixels 108 to be adjusted based on the display mapping (e.g., a bitmap) generated by the display mapping circuitry 304 for the covered area(s) of the display screen 106.

The display temperature analysis circuitry 702 monitors the temperature of the display screen 106 over time to detect changes in the temperature of the display screen 106. In some examples, the parameter adjustment identification circuitry 704 instructs the parameter(s) to return to prior operating conditions and/or values (e.g., prior processing speeds before the instruction(s) 624 were output) when the display temperature analysis circuitry 702 determines that the display screen temperature is below the temperature threshold(s) 714.

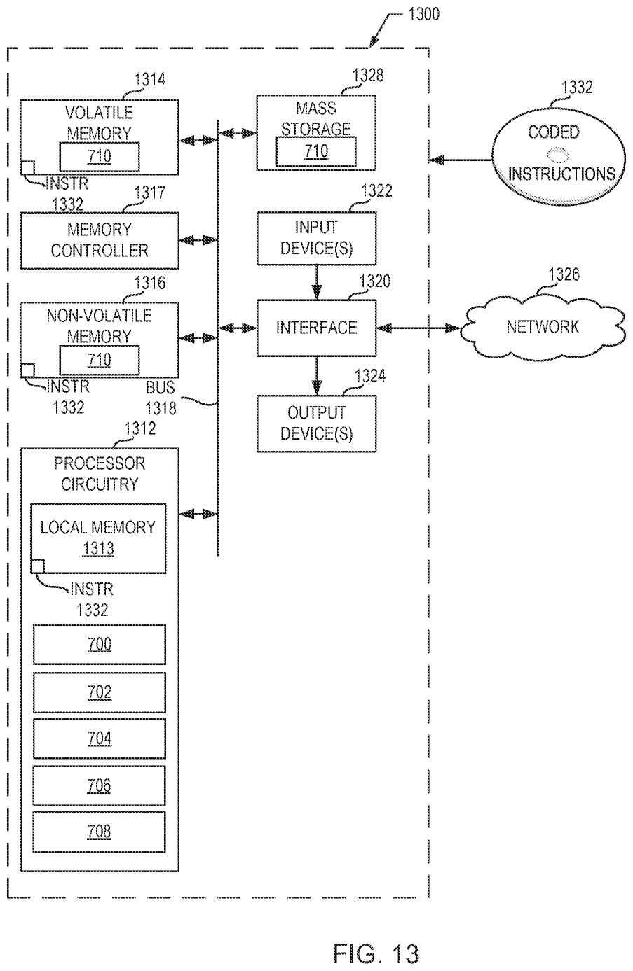

In some examples, the display temperature control circuitry 146 includes means for detecting a stylus. For example, the means for detecting a stylus may be implemented by the stylus detection circuitry 700. In some examples, the stylus detection circuitry 700 may be instantiated by processor circuitry such as the example processor circuitry 1312 of FIG. 13. For instance, the stylus detection circuitry 700 may be instantiated by the example microprocessor 1400 of FIG. 14 executing machine executable instructions such as those implemented by at least blocks 1002, 1016 of FIG. 10. In some examples, the stylus detection circuitry 700 may be instantiated by hardware logic circuitry, which may be implemented by an ASIC, XPU, or the FPGA circuitry 1500 of FIG. 15 structured to perform operations corresponding to the machine readable instructions. Additionally or alternatively, the stylus detection circuitry 700 may be instantiated by any other combination of hardware, software, and/or firmware. For example, the stylus detection circuitry 700 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the display temperature control circuitry 146 includes means for analyzing a display screen temperature. For example, the means for analyzing a display screen temperature may be implemented by the display temperature analysis circuitry 702. In some examples, the display temperature analysis circuitry 702 may be instantiated by processor circuitry such as the example processor circuitry 1312 of FIG. 13. For instance, the display temperature analysis circuitry 702 may be instantiated by the example microprocessor 1400 of FIG. 14 executing machine executable instructions such as those implemented by at least blocks 1004, 1006, 1012 of FIG. 10. In some examples, the display temperature analysis circuitry 702 may be instantiated by hardware logic circuitry, which may be implemented by an ASIC, XPU, or the FPGA circuitry 1500 of FIG. 15 structured to perform operations corresponding to the machine readable instructions. Additionally or alternatively, the display temperature analysis circuitry 702 may be instantiated by any other combination of hardware, software, and/or firmware. For example, the display temperature analysis circuitry 702 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the display temperature control circuitry 146 includes means for identifying parameter adjustments. For example, the means for identifying parameter adjustments may be implemented by the parameter adjustment identification circuitry 704. In some examples, the parameter adjustment identification circuitry 704 may be instantiated by processor circuitry such as the example processor circuitry 1312 of FIG. 13. For instance, the parameter adjustment identification circuitry 704 may be instantiated by the example microprocessor 1400 of FIG. 14 executing machine executable instructions such as those implemented by at least blocks 1008, 1010, 1014 of FIG. 10. In some examples, the parameter adjustment identification circuitry 704 may be instantiated by hardware logic circuitry, which may be implemented by an ASIC, XPU, or the FPGA circuitry 1500 of FIG. 15 structured to perform operations corresponding to the machine readable instructions. Additionally or alternatively, the parameter adjustment identification circuitry 704 may be instantiated by any other combination of hardware, software, and/or firmware. For example, the parameter adjustment identification circuitry 704 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the display temperature control circuitry 146 includes means for interfacing. For example, the means for interfacing may be implemented by the interface communication circuitry 708. In some examples, the interface communication circuitry 708 may be instantiated by processor circuitry such as the example processor circuitry 1312 of FIG. 13. For instance, the interface communication circuitry 708 may be instantiated by the example microprocessor 1400 of FIG. 14 executing machine executable instructions such as those implemented by at least blocks 1010, 1014 of FIG. 10. In some examples, the interface communication circuitry 708 may be instantiated by hardware logic circuitry, which may be implemented by an ASIC, XPU, or the FPGA circuitry 1500 of FIG. 15 structured to perform operations corresponding to the machine readable instructions. Additionally or alternatively, the interface communication circuitry 708 may be instantiated by any other combination of hardware, software, and/or firmware. For example, the interface communication circuitry 708 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the display temperature control circuitry 146 includes means for timing. For example, the means for timing may be implemented by the timing circuitry 706. In some examples, the timing circuitry 706 may be instantiated by processor circuitry such as the example processor circuitry 1312 of FIG. 13. For instance, the timing circuitry 706 may be instantiated by the example microprocessor 1400 of FIG. 14 executing machine executable instructions such as those implemented by at least blocks 1012 of FIG. 10. In some examples, the timing circuitry 706 may be instantiated by hardware logic circuitry, which may be implemented by an ASIC, XPU, or the FPGA circuitry 1500 of FIG. 15 structured to perform operations corresponding to the machine readable instructions. Additionally or alternatively, the timing circuitry 706 may be instantiated by any other combination of hardware, software, and/or firmware. For example, the timing circuitry 706 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the display temperature control circuitry 146 of FIG. 1 is illustrated in FIG. 7, one or more of the elements, processes, and/or devices illustrated in FIG. 7 may be combined, divided, re-arranged, omitted, eliminated, and/or implemented in any other way. Further, the example stylus detection circuitry 700, the example display temperature analysis circuitry 702, the example parameter adjustment identification circuitry 704, the example timing circuitry 706, the example interface communication circuitry 708, and/or, more generally, the example display temperature control circuitry 146 of FIG. 1, may be implemented by hardware alone or by hardware in combination with software and/or firmware. Thus, for example, any of the example stylus detection circuitry 700, the example display temperature analysis circuitry 702, the example parameter adjustment identification circuitry 704, the example timing circuitry 706, the example interface communication circuitry 708, and/or, more generally, the example display temperature control circuitry 146, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example display temperature control circuitry 146 of FIG. 1 may include one or more elements, processes, and/or devices in addition to, or instead of, those illustrated in FIG. 7, and/or may include more than one of any or all of the illustrated elements, processes, and devices.

A flowchart representative of example machine readable instructions, which may be executed to configure processor circuitry to implement the touch control circuitry 112 of FIG. 2 is shown in FIG. 8. A flowchart representative of example machine readable instructions, which may be executed to configure processor circuitry to implement the pixel control circuitry 144 of FIG. 3 is shown in FIG. 9. A flowchart representative of example machine readable instructions, which may be executed to configure processor circuitry to implement the display temperature control circuitry 146 of FIG. 7 is shown in FIG. 10. The machine readable instructions may be one or more executable programs or portion(s) of an executable program for execution by processor circuitry, such as the processor circuitry 1112, 1212, 1312 shown in the example processor platform 1100, 1200, 1300 discussed below in connection with FIGS. 11-13 and/or the example processor circuitry discussed below in connection with FIGS. 14 and/or 15. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 8, 9, and/or 10, many other methods of implementing the example touch control circuitry 112, the example pixel control circuitry 144, and/or the example display temperature control circuitry 146 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8-10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed and/or instantiated by processor circuitry to distinguish between intended touch event(s) on the display screen 106 of the electronic device 102 associated with, for instance, usage of the stylus 104, and unintended touch event(s) on the display screen 106 that may occur when the user is resting portion(s) of his or her hand(s) and/or arm(s) on the display screen 106 while using the stylus 104. The machine readable instructions and/or the operations 800 of FIG. 8 begin at block 802, at which the touch location detection circuitry 200 determines the location(s) of the touch event(s) on the display screen 106 based on signals output by the display screen touch sensor(s) 110.

At block 804, the palm rejection analysis circuitry 202 executes the palm rejection algorithm(s) 208 to classify the touch event(s) as (a) intended touch event(s) representing, for instance, user input(s) via the stylus 104, or (b) unintended touch event(s) representing, for instance, contact between the user and the display screen while using the stylus 104 but not user input(s) intended to invoke a response from the device 102. The palm rejection analysis circuitry 202 can detect the unintended touch events based on, for example, a size and/or location of the touch event(s) relative to the display screen 106.

In examples in which the palm rejection analysis circuitry 202 detects the unintended touch event(s) (block 806), then at block 808 the palm rejection analysis circuitry 202 causes the unintended touch event location data 214 including the locations of the unintended touch events to be output for analysis by the pixel control circuitry 144 and/or the display temperature control circuitry 146 of the device 102. The example instructions 800 end when no further data indicative of touch event(s) on the display screen 106 has been received and the electronic device 102 is powered off (blocks 810, 812, 814).

FIG. 9 is a flowchart representative of example machine readable instructions and/or example operations 900 that may be executed and/or instantiated by processor circuitry to adjust properties (e.g., pixel properties, backlight properties) of the display screen 106 of the electronic device 102 of FIG. 1 in response to identification of area(s) of the display screen 106 that are covered, substantially covered, or likely to be covered by portion(s) of the user's body (e.g., hand(s) and/or arm(s)) during, for instance, use of the stylus 104 with the display screen 106. The machine readable instructions and/or the operations 900 of FIG. 9 begin at block 902, at which the body shape identification circuitry 300 determines if unintended touch event location data 214 indicative of unintended touch event(s) on the display screen 106 due user contact with the display screen 106 has been received from the touch control circuitry 112. If the touch event location data 214 has not been received, then at block 904, the hovering body detection circuitry 302 analyzes sensor data 320 from the image sensor(s) 136 and/or the presence detection sensor(s) 138 to determine (e.g., predict) if portion(s) of the user's hand(s) and/or arm(s) are hovering over and, thus, covering portion(s) of the display screen 106.

In examples in which the body shape identification circuitry 300 receives the unintended touch event location data 214 and/or the hovering body detection circuitry 302 predicts the presence of the hovering hand(s) and/or arm(s) of the user relative to the display screen 106, then at block 906 the body shape identification circuitry 300 determines (e.g., predicts) a shape of the portion(s) of the hand(s) and/or arm(s) in contact with or hovering over the display screen 106. For example, the body shape identification circuitry 300 executes the body shape prediction algorithm(s) 316 to predict the shape(s) of the portion(s) of the user's hand(s) and/or arm(s) based on the unintended touch event location data 214 and/or the sensor data 320. In some examples, the body shape identification circuitry 300 executes the body shape prediction algorithm(s) 316 to predict movement(s) of the user's hand(s) and/or arm(s) relative to the display screen 106 and, thus, predict the shape(s) of the portion(s) of the user's hand(s) and/or arm(s) likely to cover the display screen 106.

At block 908, the display mapping circuitry 304 generates a display coverage map 326 (e.g., a bitmap) identifying the shape(s) and location(s) of the portion(s) of the user's hand(s) and/or arm(s) relative to the display screen 106 (or the predicted shape(s)/location(s) of the hand(s) and/or arm(s) based on predicted movement(s)).

At block 910, the threshold evaluation circuitry 306 determines if the amount of the display screen 106 covered by the user's hand(s) and/or arm(s) satisfies the threshold condition rule(s) 330 such that adjusting the display screen pixels 108 and/or the backlight 109 within the covered area(s) of the display screen 106 would provide power savings. In some examples, the threshold evaluation circuitry 306 determines if time threshold(s) for a duration of the unintended touch events on display screen 106 have been satisfied such that adjusting pixels 108 and/or the backlight 109 within the covered area(s) of the display screen would provide power savings.

In examples in which the thresholds 330 have been satisfied, the pixel identification circuitry 308 identifies the pixels 108 located within the area(s) of the display screen 106 covered by the user's hand(s) and/or arm(s) at block 912. In some examples, the pixel identification circuitry 308 identifies portions of the backlight 109 to be adjusted relative to the display screen 106. At block 914, the spatial/temporal smoothing circuitry 310 applies the spatial and/or temporal smoothing algorithm(s) 332 to determine if the pixels 108 identified by the pixel identification circuitry 308 should be adjusted to prevent or substantially prevent artifacts on the display screen 106 (e.g., areas of the display screen 106 having the adjusted pixels 108 that would be visible to the user due to, for instance, movement of the user's arm). At block 916, the pixel identification circuitry 308 causes instructions 624 identifying pixels 108 that are to be adjusted (e.g., turned off, dimmed, made static) to be output for transmission to, for instance, the timing controller circuitry 130 and/or the display driver control circuitry 132. In some examples, the instructions 624 include instructions with respect to adjusting a brightness of the backlight 109 of the display panel 105. In some examples, the instruction(s) 334 includes pixels 108 to be adjusted based on predicted movement(s) of the user's hand(s) and/or arm(s) and, thus, likely areas of the display screen 106 to be covered or uncovered as a result of the predicted movement(s)). In such examples, the instruction(s) 334 can increase a response time of the device 112 in adjusting the pixels 108 (e.g., turning off or dimming certain pixels 108, turning on or brightening certain pixels 108 based on predicted changes in coverage of the display screen 106). The example instructions 900 of FIG. 9 end when no further unintended touch event(s) and/or hovering portions of the user body of the user have been detected and the electronic device is powered off (blocks 918, 920, 922).

FIG. 10 is a flowchart representative of example machine readable instructions and/or example operations 1000 that may be executed and/or instantiated by processor circuitry to select one or more parameters (e.g., operating parameter(s), processing parameter(s), display parameter(s)) of the electronic device 102 of FIG. 1 to be adjusted based on a temperature of the display screen 106 (i.e., a skin or exterior surface of the display panel 105) of the device 102. The machine readable instructions and/or the operations 1000 of FIG. 10 begin at block 1002, at which the stylus detection circuitry 700 detect user interaction(s) with the display screen 106 of the device 102. For example, the stylus detection circuitry 700 determines if use of the stylus 104 with the display screen 106 has been detected. The stylus detection circuitry 700 can detect the use of the stylus 104 based on, for example, touch event location data 212, 214 generated by the touch control circuitry 112 and indicative of intended and/or unintended touch events on the display screen 106. The stylus detection circuitry 700 can detect other user interactions with the display screen 106 indicative of contact between the user and the display screen 106 for a threshold period of time, such as the user resting his or her arms on the display screen 106 while playing a game or reading or scrolling through a document.

In examples in which the stylus detection circuitry 700 detects the stylus 104 and/or other user interactions on the display screen 106, then at block 1004, the display temperature analysis circuitry 702 determines the temperature of the display screen 106 at a given time based on the display screen temperature data 712 generated by the temperature sensor(s) 140 of the display panel 105. At block 1006, the display temperature analysis circuitry 702 performs a comparison of the temperature of the display screen 106 to the display screen temperature threshold(s) 714.

In examples in which the display temperature analysis circuitry 702 determines that the display screen temperature does not exceed the display screen temperature threshold(s) 714, the stylus detection circuitry 700 and the display temperature analysis circuitry 702 continue to monitor the display screen temperature during stylus usage (blocks 1002, 1004).

In examples in which the display temperature analysis circuitry 702 determines that the display screen temperature exceeds the temperature threshold(s) 714, the parameter adjustment identification circuitry 704 identifies parameter(s) of the device 102 to adjust to decrease the amount of heat generated by the device 102 based on the device parameter adjustment rule(s) 716 at block 1008. For example, the parameter adjustment identification circuitry 704 can determine that the (e.g., main) processor circuitry 114 should be throttled, that the charging rate of the battery should be reduced, and/or that the pixels 108 in the area(s) of the display screen 106 covered by the user's hand(s) and/or arm(s) during use of the stylus should be adjusted (e.g., turned off, dimmed, made static).

At block 1010, the parameter adjustment identification circuitry 704 outputs the instructions to cause the adjustments to the parameters (e.g., charging rate, clock speed, displays pixel properties) to be implemented. In some examples, the parameter adjustment identification circuitry 704 outputs the instructions after the timing circuitry 706 verifies that the stylus usage has been detected for a threshold amount of time, which can indicate extended or prolonged contact between the user and the display screen such that the user may feel the heat emitted by the display screen 106 (as compared to, for instance, quick taps using the finger(s)).

At block 1012, the display temperature analysis circuitry 702 monitors the temperature of the display screen to determine if the display screen temperature is below the temperature threshold(s) 714 as a result of the adjustment(s) to the device parameter(s). In some examples, the timing circuitry 706 determines if the timing rule(s) 718 for adjusting the parameters (e.g., maintaining the CPU at a reduced processing speed) have been exceeded such that the user experience with the device 102 could be affected. If the display temperature analysis circuitry 702 determines that the display screen temperature is below the temperature threshold(s) 714 and/or if the timing circuitry 706 determines that the timing rule(s) 718 for the parameters adjustment(s) have been satisfied or exceeded, then at block 1014, the parameter adjustment identification circuitry 704 outputs instructions to cause the parameter(s) to be, for instance, adjusted or returned to previous values (e.g., a previous clock speed, a previous charging rate) before the adjustments at block 1008, 1010.

If the display temperature analysis circuitry 702 determines that the display screen temperature is not below the temperature threshold(s) 714 and/or the timing circuitry 706 determines that the timing rule(s) 718 for the parameters adjustment(s) have not yet been satisfied or exceeded, the parameter adjustment identification circuitry 704 can continue to tune or adjust the parameters of the device 102 to control the heat generated by the device 102 and, thus, the display screen temperature. The example instructions 1000 of FIG. 10 end when the stylus detection circuitry 700 no longer detects use of the stylus and the device 102 is powered off (blocks 1016, 1018, 1020).

FIG. 11 is a block diagram of an example processor platform 1100 structured to execute and/or instantiate the machine readable instructions and/or the operations of FIG. 8 to implement the touch control circuitry 112 of FIGS. 1 and/or 2. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the example touch location detection circuitry 200, the example palm rejection analysis circuitry 202, and the example interface communication circuitry 204.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1132, which may be implemented by the machine readable instructions of FIG. 8, may be stored in the mass storage device 1128, in the volatile memory 1114, in the non-volatile memory 1116, and/or on a removable non-transitory computer readable storage medium such as a CD or DVD.

FIG. 12 is a block diagram of an example processor platform 1200 structured to execute and/or instantiate the machine readable instructions and/or the operations of FIG. 9 to implement the pixel control circuitry 144 of FIGS. 1 and/or 3. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs, microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 412 implements the example body shape identification circuitry 300, the example hovering body detection circuitry 302, the example display mapping circuitry 304, the example threshold evaluation circuitry 306, the example pixel identification circuitry 308, the example spatial/temporal smoothing circuitry 310, and the example interface communication circuitry 312.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1232, which may be implemented by the machine readable instructions of FIG. 9, may be stored in the mass storage device 1228, in the volatile memory 1214, in the non-volatile memory 1216, and/or on a removable non-transitory computer readable storage medium such as a CD or DVD.

FIG. 13 is a block diagram of an example processor platform 1300 structured to execute and/or instantiate the machine readable instructions and/or the operations of FIG. 10 to implement the display temperature control circuitry 146 of FIGS. 1 and/or 7. The processor platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing device.

The processor platform 1300 of the illustrated example includes processor circuitry 1312. The processor circuitry 1312 of the illustrated example is hardware. For example, the processor circuitry 1312 can be implemented by one or more integrated circuits, logic circuits, FPGAs, microprocessors, CPUs, GPUs, DSPs, and/or microcontrollers from any desired family or manufacturer. The processor circuitry 1312 may be implemented by one or more semiconductor based (e.g., silicon based) devices. In this example, the processor circuitry 1312 implements the example stylus detection circuitry 700, the example display temperature analysis circuitry 702, the example parameter adjustment identification circuitry 704, the example timing circuitry 706, and the example interface communication circuitry 708.

The processor circuitry 1312 of the illustrated example includes a local memory 1313 (e.g., a cache, registers, etc.). The processor circuitry 1312 of the illustrated example is in communication with a main memory including a volatile memory 1314 and a non-volatile memory 1316 by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317.

The processor platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user to enter data and/or commands into the processor circuitry 1312. The input device(s) 1322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1300 of the illustrated example also includes one or more mass storage devices 1328 to store software and/or data. Examples of such mass storage devices 1328 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1332, which may be implemented by the machine readable instructions of FIG. 10, may be stored in the mass storage device 1328, in the volatile memory 1314, in the non-volatile memory 1316, and/or on a removable non-transitory computer readable storage medium such as a CD or DVD.

FIG. 14 is a block diagram of an example implementation of the processor circuitry 1112 of FIG. 11, the processor circuitry 1212 of FIG. 12, and/or the processor circuitry 1312 of FIG. 13. In this example, the processor circuitry 1112 of FIG. 11, the processor circuitry 1212 of FIG. 12, and/or the processor circuitry 1312 of FIG. 13 is implemented by a microprocessor 1400. For example, the microprocessor 1400 may be a general purpose microprocessor (e.g., general purpose microprocessor circuitry). The microprocessor 1400 executes some or all of the machine readable instructions of the flowcharts of FIGS. 8, 9, and/or 10 to effectively instantiate the touch control circuitry 112 of FIG. 2, the pixel control circuitry 144 of FIG. 3, and/or the display temperature control circuitry 144 of FIG. 7 as logic circuits to perform the operations corresponding to those machine readable instructions. In some such examples, the circuitry of FIGS. 2, 3, and/or 7 is instantiated by the hardware circuits of the microprocessor 1400 in combination with the instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 8, 9, and/or 10.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1114, 1116 of FIG. 11; the main memory 1214, 1216 of FIG. 12; the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating point operations. In yet other examples, the AL circuitry 1416 may include first AL circuitry that performs integer based operations and second AL circuitry that performs floating point operations. In some examples, the AL circuitry 1416 may be referred to as an Arithmetic Logic Unit (ALU). The registers 1418 are semiconductor-based structures to store data and/or instructions such as results of one or more of the operations performed by the AL circuitry 1416 of the corresponding core 1402. For example, the registers 1418 may include vector register(s), SIMD register(s), general purpose register(s), flag register(s), segment register(s), machine specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure including distributed throughout the core 1402 to shorten access time. The second bus 1422 may be implemented by at least one of an I2C bus, a SPI bus, a PCI bus, or a PCIe bus

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 15 is a block diagram of another example implementation of the processor circuitry 1112 of FIG. 11, the processor circuitry 1212 of FIG. 12, and/or the process or circuitry 1312 of FIG. 13. In this example, the processor circuitry 1112, 1212, 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the machine readable instructions in hardware and, thus, can often execute the operations faster than they could be performed by a general purpose microprocessor executing the corresponding software.

More specifically, in contrast to the microprocessor 1400 of FIG. 14 described above (which is a general purpose device that may be programmed to execute some or all of the machine readable instructions represented by the flowcharts of FIGS. 8, 9, and/or 10 but whose interconnections and logic circuitry are fixed once fabricated), the FPGA circuitry 1500 of the example of FIG. 15 includes interconnections and logic circuitry that may be configured and/or interconnected in different ways after fabrication to instantiate, for example, some or all of the machine readable instructions represented by the flowcharts of FIGS. 8, 9, and/or 10. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the software represented by the flowcharts of FIGS. 8, 9, and/or 10. As such, the FPGA circuitry 1500 may be structured to effectively instantiate some or all of the machine readable instructions of the flowcharts of FIGS. 8, 9, and/or 10 as dedicated logic circuits to perform the operations corresponding to those software instructions in a dedicated manner analogous to an ASIC. Therefore, the FPGA circuitry 1500 may perform the operations corresponding to the some or all of the machine readable instructions of FIGS. 8, 9, and/or 10 faster than the general purpose microprocessor can execute the same.

In the example of FIG. 15, the FPGA circuitry 1500 is structured to be programmed (and/or reprogrammed one or more times) by an end user by a hardware description language (HDL) such as Verilog. The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain machine readable instructions to configure the FPGA circuitry 1500, or portion(s) thereof. In some such examples, the configuration circuitry 1504 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1506 may be implemented by external hardware circuitry. For example, the external hardware 1506 may be implemented by the microprocessor 1400 of FIG. 14. The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations that may correspond to at least some of the machine readable instructions of FIGS. 8, 9, and/or 10 and/or other desired operations. The logic gate circuitry 1508 shown in FIG. 15 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example Dedicated Operations Circuitry 1514. In this example, the Dedicated Operations Circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the processor circuitry 1112 of FIG. 11, the processor circuitry 1212 of FIG. 12, and/or the processor circuitry 1312 of FIG. 13, many other approaches are contemplated. For example, as mentioned above, modern FPGA circuitry may include an on-board CPU, such as one or more of the example CPU 1520 of FIG. 15. Therefore, the processor circuitry 1112 of FIG. 11, the processor circuitry 1212 of FIG. 12, and/or the processor circuitry 1312 of FIG. 13 may additionally be implemented by combining the example microprocessor 1400 of FIG. 14 and the example FPGA circuitry 1500 of FIG. 15. In some such hybrid examples, a first portion of the machine readable instructions represented by the flowcharts of FIGS. 8, 9, and/or 10 may be executed by one or more of the cores 1402 of FIG. 14, a second portion of the machine readable instructions represented by the flowchart of FIGS. 8, 9, and/or 10 may be executed by the FPGA circuitry 1500 of FIG. 15, and/or a third portion of the machine readable instructions represented by the flowcharts of FIGS. 8, 9, and/or 10 may be executed by an ASIC. It should be understood that some or all of the circuitry of FIGS. 2, 3, and/or 7 may, thus, be instantiated at the same or different times. Some or all of the circuitry may be instantiated, for example, in one or more threads executing concurrently and/or in series. Moreover, in some examples, some or all of the circuitry of FIGS. 2, 3, and/or 7 may be implemented within one or more virtual machines and/or containers executing on the microprocessor.

In some examples, the processor circuitry 412 of FIG. 4 may be in one or more packages. For example, the microprocessor 1400 of FIG. 14 and/or the FPGA circuitry 1500 of FIG. 15 may be in one or more packages. In some examples, an XPU may be implemented by the processor circuitry 412 of FIG. 4, which may be in one or more packages. For example, the XPU may include a CPU in one package, a DSP in another package, a GPU in yet another package, and an FPGA in still yet another package.

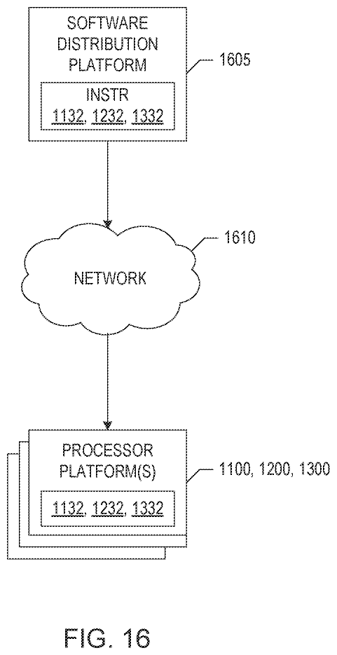

A block diagram illustrating an example software distribution platform 1605 to distribute software such as the example machine readable instructions 1132 of FIG. 11, the example machine readable instructions 1232 of FIG. 12, and/or the example machine readable instructions 1232 of FIG. 13 to hardware devices owned and/or operated by third parties is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1132 of FIG. 11, the example machine readable instructions 1232 of FIG. 12, and/or the example machine readable instructions 1232 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1132, which may correspond to the example machine readable instructions 800 of FIG. 8; the machine readable instructions 1232, which may correspond to the example machine readable instructions 900 of FIG. 9; and/or the machine readable instructions 1332, which may correspond to the example machine readable instructions 1000 of FIG. 10, as described above. The one or more servers of the example software distribution platform 1605 are in communication with an example network 1610, which may correspond to any one or more of the Internet and/or any of the example networks 1126, 1226, 1326 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132, 1232, 1332 from the software distribution platform 1605. For example, the software, which may correspond to the example machine readable instructions 1132 of FIG. 11, may be downloaded to the example processor platform 1100, which is to execute the machine readable instructions 1132 to implement the touch control circuitry 112. The software, which may correspond to the example machine readable instructions 1232 of FIG. 12, may be downloaded to the example processor platform 1200, which is to execute the machine readable instructions 1232 to implement the pixel control circuitry 144. The software, which may correspond to the example machine readable instructions 1332 of FIG. 13, may be downloaded to the example processor platform 1300, which is to execute the machine readable instructions 1332 to implement the display temperature control circuitry 146. In some examples, one or more servers of the software distribution platform 1605 periodically offer, transmit, and/or force updates to the software (e.g., the example machine readable instructions 1132, 1232, 1332 of FIGS. 11, 12, and/or 13) to ensure improvements, patches, updates, etc., are distributed and applied to the software at the end user devices.

From the foregoing, it will be appreciated that example systems, methods, apparatus, and articles of manufacture have been disclosed that provide for power savings at an electronic device during use of, for instance, a stylus by a user of the device to interact with the device. Examples disclosed herein track position(s) of the user's hand(s) and/or arm(s) relative to a display screen of the device to identify area(s) of the display screen that are covered, substantially covered, or likely to be covered (e.g., due to movement) by the user's hand(s) and/or arm(s) while using the stylus due to, for instance, the user resting his or her hand(s) and/or arm(s) on the display screen, hovering his or her hand(s) and/or arm(s) over the display screen, and/or moving his or he hand(s) and/or arm(s) while providing touch inputs using the stylus. Examples disclosed herein cause adjustments to the operation of the display screen (e.g., turn off pixels, dim pixels, cause the pixels to be static, reduce a brightness of a backlight) in the area(s) of the display screen covered by the user's hand(s) and/or arm(s). Examples disclosed herein may also turn on pixels as they are uncovered due to movement and/or position changes. Some examples disclosed here adjust parameters of the device such as processing speed, charging rate, etc. to reduce power consumption of the device, decrease an amount of heat generated by the device, and, as a result, decrease an amount of heat emitted by the display screen while the user may be in contact with the display screen. Examples disclosed herein dynamically tune and/or improve (e.g., optimize) performance of the device during stylus usage in view of opportunities for power savings.

Example apparatus, systems, and related methods for providing display panel power savings during stylus usage are disclosed herein. Further examples and combinations thereof include the following:

Example 1 includes an apparatus including interface circuitry to receive touch event location data indicative of touch events associated by a user on a display screen of an electronic device; and processor circuitry including one or more of at least one of a central processor unit, a graphics processor unit, or a digital signal processor, the at least one of the central processor unit, the graphics processor unit, or the digital signal processor having control circuitry, arithmetic and logic circuitry to perform one or more first operations corresponding to instructions, and one or more registers to store a result of the one or more first operations, the instructions in the apparatus; a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or Application Specific Integrated Circuitry (ASIC) including logic gate circuitry to perform one or more third operations; the processor circuitry to perform at least one of the first operations, the second operations, or the third operations to instantiate: display mapping circuitry to identify an area of the display screen covered by a portion of a body of the user based on a shape of the portion; and pixel identification circuitry to identify respective ones of pixels of the display screen in the area of the display screen; and cause a property of the respective ones of the pixels to be adjusted.

Example 2 includes the apparatus of example 1, wherein the pixel identification circuitry is to cause the pixels to at least one of turn off or dim.

Example 3 includes the apparatus of examples 1 or 2, wherein the processor circuitry is to perform at least one of the first operations, the second operations, or the third operations to instantiate hovering body detection circuitry to detect a presence of the portion of the body hovering over the display screen.

Example 4 includes the apparatus of any of examples 1-3, wherein the hovering body detection circuitry is to detect the presence of the portion of the body based on image data.

Example 5 includes the apparatus of any of examples 1-4, wherein the processor circuitry is to perform at least one of the first operations, the second operations, or the third operations to instantiate spatial and temporal smoothing circuitry to adjust the respective ones of the pixels identified by the pixel identification circuitry.

Example 6 includes the apparatus of any of examples 1-5, wherein the processor circuitry is to perform at least one of the first operations, the second operations, or the third operations to instantiate body shape identification circuitry to determine the shape of the portion of the body based on the touch event location data.

Example 7 includes the apparatus of any of examples 1-6, the processor circuitry is to perform at least one of the first operations, the second operations, or the third operations to instantiate display temperature analysis circuitry to perform a comparison of a temperature of the display screen to a threshold; and parameter adjustment identification circuitry to cause the pixels in the area to turn off.

Example 8 includes the apparatus of any of examples 1-7, wherein the parameter adjustment identification circuitry is to cause one or more of a processing speed or a charging rate of the electronic device to be adjusted.

Example 9 includes the apparatus of any of examples 1-8, wherein the touch events are associated with use of a stylus.

Example 10 includes an electronic device comprising a display; at least one memory; machine readable instructions; and processor circuitry to at least one of instantiate or execute the machine readable instructions to in response to detection of a touch event on the display, identify an area of the display covered by a portion of a hand of a user; and cause a brightness of the area of the display to decrease based on the identification of the area.

Example 11 includes the electronic device of example 10, wherein the processor circuitry is implemented by timing controller circuitry of the electronic device.

Example 12 includes the electronic device of examples 10 or 11, wherein the processor circuitry is to predict a shape of the portion of the hand covering the display based on touch event location data.

Example 13 includes the electronic device of any of examples 10-12, wherein the processor circuitry is to detect a presence of the portion of the hand relative to the display based on data corresponding to signals output by one or more of an image sensor or a presence detection sensor of the electronic device.

Example 14 includes the electronic device of any of examples 10-13, wherein the processor circuitry is to generate a bitmap identifying the portion of the hand relative to the display; and identify pixels of the display to be adjusted based on the bitmap.

Example 15 includes the electronic device of any of examples 10-14, wherein the processor circuitry is to cause the brightness of the area to decrease by causing the identified pixels to turn off or dim.

Example 16 includes the electronic device of any of examples 10-15, wherein the processor circuitry is to cause the brightness of the area to decrease by causing a brightness of a blacklight to be adjusted.

Example 17 includes the electronic device of any of examples 10-16, wherein the area is a first area and the processor circuitry is to detect change from the first area being covered by the portion of the hand to a second area of the display covered by the portion of the hand; and cause the brightness of the first area and the second area of the display to be adjusted in response to the change.

Example 18 includes the electronic device of any of examples 10-17, wherein the processor circuitry is to cause a brightness of the first area to increase and a brightness of the second area to decrease in response to the change.

Example 19 includes a non-transitory machine readable storage medium comprising instructions that, when executed, cause processor circuitry of an electronic device to at least detect a presence of a portion of a body of a user in contact with a display screen; and cause one or more parameters of the electronic device to be adjusted based on the detection of the presence of the portion of the body in contact with the display screen.

Example 20 includes the non-transitory machine readable storage medium of example 19, wherein the instructions, when executed, cause the processor circuitry to detect a first touch event on the display screen; and associate the first touch event with an input received via a stylus.

Example 21 includes the non-transitory machine readable storage medium of examples 19 or 20, wherein the instructions, when executed, cause the processor circuitry to detect the presence of the portion of the body in contact with the display screen based on a second touch event.

Example 22 includes the non-transitory machine readable storage medium of any of examples 19-21, wherein the instructions, when executed, cause the processor circuitry to determine a temperature of the display screen based on temperature sensor data; perform a comparison of the temperature to a display screen temperature threshold; and cause a battery charging rate of the electronic device to be adjusted based on the comparison.

Example 23 includes the non-transitory machine readable storage medium of any of examples 19-22, wherein the instructions, when executed, cause the processor circuitry to determine a temperature of the display screen based on temperature sensor data; perform a comparison of the temperature to a display screen temperature threshold; and cause a clock speed associated with the electronic device to be adjusted based on the comparison.

Example 24 includes the non-transitory machine readable storage medium of any of examples 19-23, wherein the instructions, when executed, cause the processor circuitry to determine a shape of the portion of the body of the user in contact with the display screen; determine a location of the portion of the body relative to the display screen based on touch event location data; define an area of the display screen covered by the portion of the body based on the shape and the location; and cause pixels in the area to be adjusted.

Example 25 includes the non-transitory machine readable storage medium of any of examples 19-24, wherein the processor circuitry is to determine an amount of the display screen covered by the portion of the body; and cause the pixels in the area to be adjusted in response to the amount satisfying a display screen coverage threshold.

Example 26 includes the non-transitory machine readable storage medium of any of examples 19-25, wherein the instructions, when executed, cause the processor circuitry to cause respective ones of the pixels to turn off or dim.

Example 27 includes the non-transitory machine readable storage medium of any of examples 19-26, wherein the instructions, when executed, cause the processor circuitry to generate a bitmap to identify the locations of the pixels to be adjusted.

Example 28 includes an apparatus comprising means for identifying a shape of a portion of a body of a user of an electronic device relative to a display of the electronic device; means for mapping the shape of the portion of the body relative to the display, the means for mapping to generate a map identifying an area of the display covered by the portion of the body; and means for identifying pixels, the pixel identifying means to cause the pixels to be turned off based on the map.

Example 29 includes the apparatus of example 28, further including means for performing smoothing to modify the pixels selected by the pixel identifying means to be turned off.

Example 30 includes the apparatus of examples 28 or 29, wherein the shape identifying means is to predict the shape based on image data.

Example 31 includes the apparatus of any of examples 28-30, further including means for performing palm rejection analysis to classify a touch event as an unintended touch event, the shape identifying means to determine the shape based on location data associated with the unintended touch event.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
interface circuitry to receive touch event location data indicative of touch events associated by a user on a display screen of an electronic device; and
processor circuitry including one or more of:
at least one of a central processor unit, a graphics processor unit, or a digital signal processor, the at least one of the central processor unit, the graphics processor unit, or the digital signal processor having control circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations;
the processor circuitry to perform at least one of the first operations, the second operations, or the third operations to instantiate:
display mapping circuitry to identify an area of the display screen covered by a portion of a body of the user based on a shape of the portion; and
pixel identification circuitry to:
identify respective ones of pixels of the display screen in the area of the display screen; and
cause a property of the respective ones of the pixels to be adjusted.

2. The apparatus of claim 1, wherein the pixel identification circuitry is to cause the pixels to at least one of turn off or dim.

3. The apparatus of claim 1, wherein the processor circuitry is to perform at least one of the first operations, the second operations, or the third operations to instantiate hovering body detection circuitry to detect a presence of the portion of the body hovering over the display screen.

4. (canceled)

5. (canceled)

6. The apparatus of claim 1, wherein the processor circuitry is to perform at least one of the first operations, the second operations, or the third operations to instantiate body shape identification circuitry to determine the shape of the portion of the body based on the touch event location data.

7. The apparatus of claim 1, the processor circuitry is to perform at least one of the first operations, the second operations, or the third operations to instantiate:
display temperature analysis circuitry to perform a comparison of a temperature of the display screen to a threshold; and
parameter adjustment identification circuitry to cause the pixels in the area to turn off

8. The apparatus of claim 7, wherein the parameter adjustment identification circuitry is to cause one or more of a processing speed or a charging rate of the electronic device to be adjusted.

9. The apparatus of claim 1, wherein the touch events are associated with use of a stylus.

10. An electronic device comprising:
a display;
at least one memory;
machine readable instructions; and
processor circuitry to at least one of instantiate or execute the machine readable instructions to:
in response to detection of a touch event on the display, identify an area of the display covered by a portion of a hand of a user; and
cause a brightness of the area of the display to decrease based on the identification of the area.

11. (canceled)

12. (canceled)

13. The electronic device of claim 10, wherein the processor circuitry is to detect a presence of the portion of the hand relative to the display based on data corresponding to signals output by one or more of an image sensor or a presence detection sensor of the electronic device.

14. The electronic device of claim 10, wherein the processor circuitry is to:
generate a bitmap identifying the portion of the hand relative to the display; and
identify pixels of the display to be adjusted based on the bitmap.

15. The electronic device of claim 14, wherein the processor circuitry is to cause the brightness of the area to decrease by causing the identified pixels to turn off or dim.

16. The electronic device of claim 10, wherein the processor circuitry is to cause the brightness of the area to decrease by causing a brightness of a blacklight to be adjusted.

17. The electronic device of claim 10, wherein the area is a first area and the processor circuitry is to:
detect change from the first area being covered by the portion of the hand to a second area of the display covered by the portion of the hand; and
cause the brightness of the first area and the second area of the display to be adjusted in response to the change.

18. The electronic device of claim 17, wherein the processor circuitry is to cause a brightness of the first area to increase and a brightness of the second area to decrease in response to the change.

19. A non-transitory machine readable storage medium comprising instructions that, when executed, cause processor circuitry of an electronic device to at least:
detect a presence of a portion of a body of a user in contact with a display screen; and
cause one or more parameters of the electronic device to be adjusted based on the detection of the presence of the portion of the body in contact with the display screen.

20. The non-transitory machine readable storage medium of claim 19, wherein the instructions, when executed, cause the processor circuitry to:
detect a first touch event on the display screen; and
associate the first touch event with an input received via a stylus.

21. The non-transitory machine readable storage medium of claim 20, wherein the instructions, when executed, cause the processor circuitry to detect the presence of the portion of the body in contact with the display screen based on a second touch event.

22. The non-transitory machine readable storage medium of claim 19, wherein the instructions, when executed, cause the processor circuitry to:
determine a temperature of the display screen based on temperature sensor data;
perform a comparison of the temperature to a display screen temperature threshold; and
cause a battery charging rate of the electronic device to be adjusted based on the comparison.

23. The non-transitory machine readable storage medium of claim 19, wherein the instructions, when executed, cause the processor circuitry to:
determine a temperature of the display screen based on temperature sensor data;
perform a comparison of the temperature to a display screen temperature threshold; and
cause a clock speed associated with the electronic device to be adjusted based on the comparison.

24. (canceled)

25. The non-transitory machine readable storage medium of claim 24, wherein the processor circuitry is to:
determine an amount of the display screen covered by the portion of the body; and
cause the pixels in the area to be adjusted in response to the amount satisfying a display screen coverage threshold.

26.-31. (canceled)
